(19) United States
(12) Patent Application Publication
(10) Pub. No.: US 2014/0012505 A1
(43) Pub. Date: Jan. 9, 2014

(54) MULTI-COMPONENT ELECTROMAGNETIC PROSPECTING APPARATUS AND METHOD OF USE THEREOF

(71) Applicant: Richard Smith, Ottawa (CA)

(72) Inventor: Richard Smith, Ottawa (CA)

(73) Assignee: LAURENTIAN UNIVERSITY OF SUDBURY, Sudbury, Ontario (CA)

(21) Appl. No.: 14/005,628

(22) PCT Filed: Mar. 27, 2012
(86) PCT No.: PCT/CA2012/000272

§ 371 Date: Sep. 17, 2013

Related U.S. Application Data
(60) Provisional application No. 61/469,931, filed on Mar. 31, 2011.

(51) Int. Cl. G01V 3/08

(52) U.S. Cl. CPC G01V 3/08
USPC 702/2

(57) ABSTRACT

Systems and methods are provided for the detection of conductive bodies using three-component electric or magnetic dipole transmitters. The fields from multiple transmitters can be combined to enhance fields at specific locations and in specific orientation. A one- two- or three-component receiver or receiver array is provided for detecting the secondary field radiated by a conductive body. The data from multiple receivers can be combined to enhance the response at a specific sensing location with a specific orientation. Another method is provided in which a three-component transmitter and receiver are separated by an arbitrary distance, and where the position and orientation of the receiver relative to the transmitter are calculated, allowing the response of a highly conductive body to be detected.

### FIELD OF THE INVENTION

This invention relates to electromagnetic prospecting methods. More particularly, this invention relates to methods of electromagnetic prospecting for conductive bodies.

### BACKGROUND OF THE INVENTION

Controlled source electromagnetic (EM) systems have been used for many years for prospecting for minerals (Grant and West, 1965; Nabighian, 1991). In more recent years, they have also been used for groundwater investigations, environmental investigations (Ward, 1990), the detection of unexploded ordnance (e.g., Billings et al., 2010) and more recently in agricultural mapping (Lück and Müller, 2009). Electromagnetic systems have also been used in resistivity logging tools (Wang et al., 2009; Davydycheva, 2010a; 2010b) and in seafloor controlled source electromagnetic (CSEM) systems (Chave and Cox, 1982; Cheesman et al., 1987; 1988; MacGregor and Sinha, 2000; Ellingsrud et al., 2002; and Constable and Srnka, 2007).

These controlled source EM systems comprise a transmitter and a receiver. The transmitter is generally a loop carrying a time varying current. According to Ampere's law, this current has a magnetic field that radiates away from the transmitter in all directions, including below the ground surface. If this field, called the primary field, varies as a function of time, then there is an electric field that circulates around the time varying magnetic field. If this electric field passes through a region of the subsurface that has a non-zero electrical conductivity, then the product of the electrical conductivity and the electric field gives a current density (Ohm's law). These currents induced in the ground are called secondary currents. The secondary currents have an associated secondary magnetic field (Ampere's law) which radiates everywhere, including above the surface of the earth, where it can be measured by a receiver coil. The receiver coil also measures the primary field that comes directly from the transmitter. Generally, there has to be some form of communication or timing link between the transmitter and the receiver so that the measured field can be decomposed into a field that is similar in shape and timing (phase) to the primary. This component is called the “in-phase” response. Anything that is not in-phase can be considered the out-of-phase or “quadrature phase” component. The systems that have transmitter current waveforms that are sinusoidal are classified as frequency-domain systems, ones with waveforms that switch off suddenly in some manner are known as time-domain systems. Both time and frequency domain systems have in-phase and quadrature components (Smith, 2001).

Systems have been designed to have the transmitters and receivers on the ground and mounted on aircraft. In some cases the transmitters and receivers are connected to the aircraft, in other cases the transmitter is attached to the aircraft and the receiver towed by a long cable behind the aircraft and housed in a “bird”. There is an enormous variety of EM systems operating with different geometrical configurations and different waveforms.

EM systems generally fall into two categories: profiling methods and large-loop methods (Frischknecht et al., 1991; Parasnis, 1991; Nabighian and Macnae, 1991). In the profiling methods, the transmitters and receivers move together over the volume to be investigated with the transmitter and receiver a fixed distance apart. In some cases, more than one separation will be used to provide more data or to look to different depths. The large-loop methods generally have the transmitter in one location and the receiver in multiple locations. In some cases, multiple transmitter loop locations will be used to provide more data or to excite the earth at different locations or with a primary field with different directions. The receivers can be on the ground or airborne and the transmitters can be airborne or on the ground. Semi airborne methods have one subsystem (e.g. the transmitter) on the ground and the other in the air (Smith et al., 2001).

The Slingram or horizontal loop EM systems (Telford et al., 1976; Frischknecht et al., 1991) are a simple example of a profiling system. These systems generally use a single component transmitter and a single component receiver at a fixed separation. The airborne methods generally use a transmitter and receiver pair at a particular separation. The early airborne systems used one transmitter and one receiver (Davidson, U.S. Pat. No. 2,652,530). Additional information about the geometry of the target in the ground was obtained using two pairs of transmitters and receivers, one pair coaxial, where the transmitter and receiver coils are aligned so that their dipole direction (or normal vector) is pointed along the direction of flight and one pair coplanar, where the transmitter and receiver coils lie in a common plane—generally horizontal (Fraser, 1979; Fraser, U.S. Pat. No. 4,367,439). It was also recognized that using a single transmitter and multiple component receivers could also provide extra geometric information (Fraser, 1972; Annan, 1986; Best and Bremner, 1986; and Smith and Keating, 1996). Specifically, Fraser (1972) and Smith and Keating (1996) showed that it was possible to determine the depth, dip strike and offset of conductors with the information from multiple receiver components. As an extension to this concept, Hogg (1986) proposed a system with three component receivers and two component transmitters and performed some model studies to show that the multiple components provided a wealth of data that could be used to infer the depth and orientation of the subsurface conductor.

The large loop systems (Parasnis, 1991; Nabighian and Macnae, 1991) generally have the loops laid out horizontally. Multiple receiver positions are then occupied; usually one receiver is moved sequentially over the survey area, but occasionally one or more receivers can be moved in parallel. The strength of this configuration is that the large loop has a strong field that will penetrate to great depth and excite strong currents in conductive zones. The weakness of the large loop configuration is that the magnetic field vector at any point in the ground only points in one orientation. The electric field circulating around the magnetic field is also in one orientation. If there is no conductive pathway in this orientation, then a substantial current will not be induced. In the jargon of electromagnetic prospecting, in this case, the primary field is said to couple poorly to the conductor. If the field is oriented so the electric field is aligned with a conductive pathway, then the field couples strongly to the conductor. The magnetic field directly below a large loop is vertical, so this primary field will couple well to horizontal conductors. In order to couple well to a vertical conductor, the field must be horizontal, which is only true at some distance and some depth, where the primary fields are weak. One solution to this problem is to design a loop in the shape of a figure eight symbol (8) or infinity symbol (∞), either in parallel (Spies 1975) or in series (Brube et al., U.S. Pat. No. 7,116,107 B2). If there is some uncertainty as to the orientation or location of a conductor, a well designed survey will often include a number of transmitter positions to provide multiple coupling directions in a zone of interest. Each additional large loop takes time to lay-out and thus increases the cost of the survey. Seismic methods (Telford el al, 1976) have developed the concept of arrays of receivers and transmitters (seismic sources) to reduce noise.

The ability to detect and discriminate extremely good conductors is very important in mineral exploration. This means that the highly conductive copper and nickel ore deposits can be discriminated from other less conductive bodies such as iron and zinc deposits and graphite and clay. One of the difficulties in doing this is that the response from the highly conductive body has a waveform that is identical to the waveform coming from the transmitter. This identical waveform is called an “in-phase” response or signal as it has both the same waveform and the same timing or phase as the transmitter (primary) waveform.

Because the response is in-phase, special methods are required to identify these extremely conductive deposits. One method is to make the transmitter and receiver a fixed distance apart and then use a special “bucking coil” to cancel out the primary field from the transmitter (McLaughlin, et al., U.S. Pat. No. 3,015,060; McLaughlin et al, Canadian Patent 684662). The bucking coil is usually smaller than the transmitter, closer to the receiver and is positioned and oriented so that the field from the transmitter and bucking coil cancel at the receiver. Whitton (Canadian Patent Application 2420806) proposed that the transmitting, receiving and bucking coils be concentric. For these types of systems to work well, it is necessary that the transmitter and bucking coil transmit exactly the same waveform and that the distances and orientation of all the coils do not change. These systems are called rigid boom systems and examples such as those described by Ruddock et al. (Canadian Patent 667736) and Taylor and Shaw (Canadian Patent 680143) were attached to or towed below helicopters. A patent held by De Brie Perry and Gribble (Canadian Patent 653286) mounts a pair of coaxial and a pair of coplanar transmitters a small distance below the extremes of the wing tips of a fixed-wing aircraft. The intention of their patent is to minimize the relative movement of the transmitter and receiver coils, so they are attempting to make the system as rigid as possible. Methods that orient the receiver so that it is null coupled with the transmitter (e.g. Davidson, U.S. Pat. No. 2,652,530; Ruddock and Brant, U.S. Pat. No. 2,887,650) will also measure no primary field. These methods also rely on the geometry being held rigid. Bucking coils have been proposed for non-rigid systems (Puranen and Kahma, U.S. Pat. No. 2,741,736), but never implemented successfully as it is labourious, time consuming and costly (Robinson, Canadian Patent 854344).

A second approach is to continually monitor the geometry of the transmitter and receiver (e.g. the lateral offset and the orientation) and then predict the field from the transmitter. This predicted field can be subtracted and the residual is the field from the extremely good conductor. Hefford et al. (2006) showed that the closer the transmitter and receiver are to each other, the more stringent the accuracy that the geometry must be known. This approach is used successfully with ground or borehole EM systems (West et al., 1984; Smith and Balch, 2000), but not with airborne systems due to the very stringent accuracy requirement.

A third approach, proposed by Zandee (Canadian Patent 1202676), suggested cross correlating a transient transmitter signal with the received signal to decompose the response into in-phase and quadrature components at a number of frequencies and to use the very low frequency in-phase signal to correct for relative motion of the transmitter and receiver. However, this system was never demonstrated to work in practice. Another patent by Zandee and Ros (Canadian Patent 1247195) suggested sending a primary compensation signal to the receiver down the tow cable.

A fourth approach is to use two transmitters with different orientations and exploit the fact that the field from these two transmitters has different amplitudes. Cartier (U.S. Pat. No. 2,623,924; Canadian Patent 564361) proposed using a coaxial and a coplanar coil pair. The field from the former will be twice as big as the field from the latter, so deviations from this ratio should identify when there are excellent conductors proximal to the electromagnetic system. This system assumes that the receivers lie along an axial line defined by the orientation of the coaxial transmitter and that the orientation of the receiver is such that the direction of the coaxial coil is along the line from the transmitter and the coplanar coil is perpendicular to this and parallel to the coplanar transmitter.

The implementation of this system had the receiver towed behind an aircraft, so the correct geometry could only be ensured at times when the winds were very calm. Cartier et al argued that the response was relatively insensitive to the relative position of the transmitter and receiver; however, they also proposed that a servo system could rotate the transmitter coils so that the axis of the coaxial coil was always pointing towards the receiver. A variation of this approach was taught by Shaw and Taylor (U.S. Pat. No. 2,955,250), who added an additional coil in the same orientation as one of the other coils, but transmitted a signal at a different frequency. A subsequent invention by Shaw and Taylor (U.S. Pat. No. 2,955,251) suggested that the relative position between the receiver and transmitter be guided by a modulated beam of light and controlled by fins on the transmitter and/or receiver.

Other methods of airborne electromagnetic systems that are not rigid, avoid the measurement of the in-phase response. Robinson (Canadian Patent 854344), suggests measuring the field in quadrature with the currents in the transmitter and the aircraft. Time domain systems (Barringer, Canadian Patent 662184; Kamenetsky et al., Canadian Patent 889478) that measure in the off-time are essentially measuring the quadrature field (Smith, 2001). Other approaches measure the total phase difference between an operating frequency and a lower frequency (Puranen and Kahma, U.S. Pat. No. 2,642,477) or differences in the response in two receivers when the transmitter radiates a rotary field (Hedstrom and Tegholm, U.S. Pat. No. 2,794,949). These systems are not sensitive to extremely conductive bodies.

Another approach taught by Seigel (U.S. Pat. No. 2,903,642) measures the in-phase distortion in the angle of the total field measured from two primary fields. However, this method is also insensitive to extremely good conductors, as the distortion of the in-phase response from the extremely good conductor will essentially be identical at both frequencies. Puranen (U.S. Pat. No. 2,931,973) teaches a method that uses two orthogonal transmitters and two orthogonal receivers and measures the in-phase and quardature components. An airborne method described by McLaughlin et al. (U.S. Pat. No. 3,014,176) proposes a single transmitter and receiver pair, a novel bird for controlling the geometry, a signal from the transmitter to cancel the receiver signal and measuring the quadrature component.

An invention taught by Nilsson (U.S. Pat. No. 4,492,924) suggested measuring the electric field, which, to the knowledge of the inventor, has not yet been successfully commercialized in an airborne EM system. Ronka (U.S. Pat. No. 3,042,857) suggested an airborne system comprising two coaxial (or coplanar) single-component transmitters with moments with opposite sign and magnitudes adjusted so that changes in geometry will result in an increase from one transmitter that nullifies the decrease from the other transmitter. The preferred embodiment suggests a three-axis receiver, a configuration that was not used in practice in an airborne electromagnetic system until the mid 1990s. Dzwinel (Canadian Patent 1188363) teaches a method that uses a single-component transmitter and a three-component receiver towed below the transmitter. The patent described here introduces the use of non-rigid, separated three-component transmitters and receivers in the electromagnetic system.

More recent patents relate to other innovations. One group proposes the use of helicopters and controlling transmitter-receiver geometry (Taylor, Canadian Patent 2187952; Kremer, Canadian Patent 2232105; Klinkert, Canadian Patent Application 2564183), but not specifically for the purposes of detecting extremely conductive bodies. Another patent suggests towing a small aircraft behind the aircraft (Klinkert, Canadian Patent 2315781). Morrison et al. in Canadian Patent Application 2450155 have designed a system with a large loop towed below an aircraft, but in the preferred embodiment, the aircraft is a helicopter. Another helicopter towed system comprising a large loop and a large minimum or null coupled receiver is described by Miles et al. in Canadian Patent Application 2584037 and U.S. Pat. No. 7,646,201.

Multi-component transmitters and receivers are used in other fields of investigation. In the aerospace engineering and medical instrumentation fields, three-component co-located orthogonal dipoles and three component co-located orthogonal dipoles are used to accurately track and determine the relative position of objects (Knipers, U.S. Pat. No. 3,868,656; Raab, U.S. Pat. No. 4,054,881; Raab et al., 1979; Anderson, U.S. Pat. No. 7,715,898; Schechter, US Patent Publication No. 2008/0309326). These systems are currently being used in a variety of applications. It has been recognized that the results provided by these instruments are perturbed by nearby conductive material (e.g. Jascob et al., U.S. Pat. No. 6,636,757; Anderson, US Patent Publication 2006/0154604; Khalfin and Jones, Canadian Patent 2388328). US Patent Publication No. 2010/0168556 provides a method for tracking a medical device where an electromagnetic error correction tool is employed to correct for local metal distortion effects. Other more complex systems have been developed subsequently (e.g. Anderson, U.S. Pat. No. 7,015,859 B2).

In the field of unexploded ordnance (UXO) detection, arrays of multiple transmitters and receivers are now being employed. The UXO detection instruments have the transmitters and receivers together in one housing that moves across the ground so they are essentially profiling instruments, housing the transmitters and receivers in one unit and intending to identify the UXO in a single pass over the ground. Generally, these UXO detection systems use an array of multiple transmitters and receivers arranged in a fixed-geometry grid (Bell et al., 2008) or a gradient measurement (e.g. Billings et al., 2010). Fan et al. (2010) have also recently proposed the use of multiple transmitters to direct the propagation direction of a field.

The ALLTEM system (Wright et al., 2006) uses a three-component transmitter and measures the vertical field response; the horizontal fields are all sensed by measuring specific gradients—primarily the vertical gradients (Asch et al., 2009; 2010). The reason for the emphasis on gradient measurements is because the sensors are very close to the transmitters, so measuring the gradient is required to cancel the strong primary field. In addition to measuring gradients, other techniques are necessary to reduce the impact of the primary field (Asch et al., 2008). One of the advantages of the ALLTEM (Wright et al., 2005) is its ability to measure the on-time response; West et al. (1984) demonstrate that this allows identification of highly conductive electromagnetic responders or ferrous objects (magnetic responders). The ability to identify these on-time responses requires that the geometry is fixed or known. This is true for the ALLTEM system. The multiple component measurements in the ALLTEM system are to provide additional geometric information about the geometry of the UXO.

A UXO system described by Zhang et al. (2010) uses a single component transmitter and a multiplicity of three-component receivers. Another UXO profiling system, named BUD (Smith et al., 2007; Gasperikova et al., 2008, Morrison and Gasperikova, US Patent Publication No. 2009/0219027), uses a three-component transmitter and eight pairs of differenced receivers (16 vertical dipoles) arranged in a fixed geometry array. Another system, the AOL (Snyder and George, 2006; Snyder et al., 2008) used a three-component transmitter and an array of three component receivers inside the horizontal transmitter loop. The Geonics UXO system EM63-3D-MK2 also used an orthogonal three-component receiver and an orthogonal three-component transmitter. In all cases, the UXO systems have the receivers rigidly connected to the transmitters. In addition, compared with the size of the targets and the size and position of the receivers, these UXO transmitters could not be considered as dipoles.

Three-component receivers have been taught in US Patent Publication No. 2010/0244843, filed by Kuzmin, where first and second sensor systems employing three-axis receivers are employed for measuring naturally occurring magnetic fields, where parameters are calculated that are independent of the rotation of the first or sensor systems. Kuzmin also teaches using the disclosed three-component receiver as part of a system that uses a single axis transmitter to generate artificial magnetic fields.

U.S. Pat. No. 4,628,266, issued to Dzwinel, discloses an electromagnetic prospecting system in which a transmitting system, suspended vertically from a helicopter, is adapted to radiate electromagnetic fields of many different frequencies and many different orientations controlled automatically. The transmitting operation is carried out over several hundred combinations of transmitting system characteristics: helicopter altitude, electromagnetic field frequency and transmitter loop inclination and direction. A receiving system, suspended vertically from the transmitting system, is adapted to detect signals of three orthogonal components of electromagnetic deviations as a function of helicopter altitude, frequency, transmitter loop orientation and receiver antenna orientation. A processing system is provided to store and process an enormous volume of data directly into probability levels of hydrocarbon presence or absence over the area explored.

Three-component transmitter and receivers have also been used in the triaxial induction tools used in the hydrocarbon exploration industry. These tools contain the transmitters and receivers a fixed distance from each other (Wang et al., 2009; Davydycheva, 2010a; 2010b) and the tool is moved up and down a borehole to measure the anisotropy of the resistivity of the sedimentary formations, any invasion zones, or any faults that make the geometry three dimensional. As the transmitters and receivers move as a single entity down the hole, these instruments are essentially acquiring a single profile down the borehole.

Unfortunately, the aforementioned systems for detecting extremely good conductors are limited by their requirement for maintaining and controlling a fixed spatial relationship between the transmitter and receiver and often lack sensitivity in detecting highly conductive bodies. A system with a three component transmitter and a three component receiver removes this limitation.

Also, the profiling methods used for EM prospecting are limited in their depth penetration and the large loop methods require that the coupling of the transmitter to the target in the subsurface be known. Accordingly, there remains a need for a versatile and sensitive electromagnetic prospecting system with improved sensitivity and directionality in locating conductive bodies.

### SUMMARY OF THE INVENTION

Embodiments provided herein utilize a three-component transmitter for electromagnetic prospecting, where the three-component transmitter can couple to any target at any orientation in the subsurface. In selected embodiments, by combining the response detected from one or more transmitters over multiple locations in a post-processing step, an array of multiple transmitters and optionally multiple receivers can be formed for achieving an improvement in the signal to noise ratio and the potential depth that the system could sense. Advantageously, such arrays of multiple three-component transmitters can be used to effectively focus the electromagnetic signal at a particular location for increased sensitivity.

Accordingly, in a first aspect, there is provided a method of electromagnetic sensing comprising the steps of: a) driving each transmitter of a three-component transmitter provided at a transmitter location to generate three multiplexed electromagnetic fields, and, while driving each transmitter of the three-component transmitter, measuring signals with each receiver of a three-component receiver provided at a receiver location, thereby obtaining nine received signals; b) repeating step (a) for a plurality of different transmitter locations, different receiver locations, or a combination thereof, thereby obtaining a set of received signals; c) selecting a sensing direction and a sensing position; d) determining a set of transmitter weights, such that wherein the weights are multiplied by electromagnetic fields produced at the sensing position by each transmitter at each transmitter location, and wherein a resulting set of weighted electromagnetic fields are summed over each transmitter location, a summed weighted field is enhanced in the sensing direction at the sensing position, and substantially suppressed at other positions and directions; e) multiplying each signal of the set of received signals by a corresponding transmitter weight, wherein, for a given three-component receiver, the corresponding transmitter weight is a weight determined in step (d) for a transmitter that was active when a signal was recorded with the given three-component receiver; f) summing a resulting set of weighted signals to obtain a focused signal; and g) inferring a presence or absence of a conductive body at the sensing position according to a strength of the focused signal.

The method may further comprise the steps of: h) selecting one or more of an additional sensing direction and an additional sensing position; and i) repeating steps d) to g), and may optionally further comprise repeating steps h) and i) one or more times to scan one or more of a spatial and angular region.

A three-component transmitter may be provided to one or more of the different transmitter locations by translating a single three-component transmitter, or alternatively a physically separate three-component transmitter may be provided at one or more of the different transmitter locations. Similarly, a three-component receiver is provided to one or more of the different receiver locations by translating a single three-component receiver, or alternatively a physically separate three-component receiver may be provided at one or more of the different receiver locations. Each three-component receiver may comprise three dipole receivers suitably arranged to be capable of detecting an electromagnetic field in any direction. The transmitter and receiver dipoles can be magnetic or electromagnetic dipoles.

The method may further comprise the step of determining, based on the set of signals, a location from which a secondary electromagnetic field was generated.

The method may further comprise the step of calculating a reference signal produced by a theoretical conductive body located at the sensing position, and comparing the reference signal with the focused signal. The step of comparing the reference signal with the focused signal may comprise cross-correlating the reference signal with the focused signal.

The multiplexed electromagnetic fields may be multiplexed in the time domain or the frequency domain.

In another aspect, there is provided a method of electromagnetic sensing comprising the steps of: a) driving each transmitter of a three-component transmitter provided at a transmitter location to generate three multiplexed electromagnetic fields, and, while driving each transmitter of the three-component transmitter, measuring signals with each receiver of a three-component receiver provided at a receiver location, thereby obtaining nine received signals; b) repeating step (a) for a plurality of different transmitter locations, different receiver locations, or a combination thereof, thereby obtaining a set of received signals; c) forming an inverse problem comprising a set of equations relating the set of received signals to secondary electromagnetic fields generated by one or more subsurface conductive body in response to primary electromagnetic fields transmitted by the three-component transmitter; and d) solving the inverse problem to obtain locations of the one or more subsurface conductive bodies.

In yet another aspect, there is provided a method of detecting the presence of a conductive body, the method comprising the steps of: providing a three-component transmitter and a three-component receiver, driving each transmitter of the three-component transmitter to generate three multiplexed electromagnetic fields; detecting the three multiplexed electromagnetic fields with each receiver of the three-component receiver, thereby obtaining measured values for nine electromagnetic field components; generating equations for predicting values of the nine electromagnetic field components; inverting the equations to estimate a position and orientation of the three-component transmitter relative to the three-component receiver; employing the position and orientation to calculate predicted values of the nine electromagnetic field components, and calculating a residual electromagnetic field by subtracting predicted values from the measured values; and inferring a presence of a conductor based on a non-zero residual electromagnetic field.

The three-component transmitter may comprise three non-coplanar dipole transmitters and the three-component receiver comprises three non-coplanar dipole receivers. The step of inverting the equations may comprise performing a non-linear iterative method.

The three-component transmitter and the three-component receiver may be separated by an initially unknown distance.

The multiplexed electromagnetic fields may be multiplexed in the time domain or the frequency domain.

In another aspect, there is provided a method of detecting the presence of a conductive body, the method comprising the steps of: providing a three-component transmitter and a three-component receiver, driving each transmitter of the three-component transmitter to generate three multiplexed electromagnetic fields; detecting the three multiplexed electromagnetic fields with each receiver of the three-component receiver; generating a set of invariant equations based on the three multiplexed electromagnetic fields; solving the invariant equations to determine a position of the three-component transmitter relative to the three-component receiver; rotating the three-component transmitter such that a transmitter of the three-component transmitter is directed along an axis passing through a location of the three-component transmitter and the three-component receiver; and inferring a presence of a conductive body based on a non-zero value of one or more invariants, or a combination thereof, that are expected to be zero in absence of the conductive body.

The three-component transmitter may comprise three non-coplanar dipole transmitters and the three-component receiver comprises three non-coplanar dipole receivers. The multiplexed electromagnetic fields may be mutually orthogonal at a location of the three-component receiver.

The three-component transmitter and the three-component receiver may be separated by an initially unknown distance.

The multiplexed electromagnetic fields may be multiplexed in a time domain or a frequency domain.

A further understanding of the functional and advantageous aspects of the invention can be realized by reference to the following detailed description and drawings.

### BRIEF DESCRIPTION OF THE DRAWINGS

Preferred embodiments of the invention will now be described, by way of example only, with reference to the drawings, in which:

FIG. 1 illustrates the magnetic field produced by a magnetic dipole at the origin directed up the z axis m=(0,0,1) (the magnitude of each vector has been multiplied by 4πr³/μ₀ to increase the magnitude of the arrows distant from the dipole).

FIG. 2 plots the vector magnetic fields at a subsurface point (−10,−10,−10) from a three-component transmitter located at the origin. The fields A, B and C are from transmitters in the X, Y and Z directions respectively.

FIG. 3 plots the vectors at the same point as in FIG. 2 when the three-component transmitter is rotated so that one axis (in this case the z axis) is aligned with the vector joining the subsurface point to the transmitter, where the dipole along the rotated z axis (Z^{R}) has a field (C^{R}) that is coaxial (also points along the axial vector); the rotated X axis (X^{R}), now pointing down and in, has a field (A^{R}) that is anti-parallel (pointing up and out); and the rotated Y axis (Y^{R}), now pointing left and in, has a field (B^{R}) that is anti-parallel, pointing right and out.

FIG. 4 illustrates the effect of multiplying the magnitude of the X transmitter by −0.5 and multiplying the Y and Z transmitters by 0.5 and then adding the resulting fields, where the resultant field at the point (−10, −10, −10) is purely in the x direction. This is equivalent to a similar linear combination of the fields A, B and C at the same point associated with the X, Y and Z component transmitters, and as a result, linear combinations of transmitters can thus direct the field at any point.

FIG. 5 illustrates the outcome when an array of multiple transmitters, all directed to give an x-directed field at (0, −10, −4) are summed together, where the field at this point (circled) is even stronger than it would be for one three-component transmitter location (note however that the field at other locations is in different orientations and can also be stronger).

FIG. 6 illustrates how a linear combination of the fields from all the transmitter locations adjusted to give a strong x-directed field at the location of interest (circled) and weak fields elsewhere (note that the relative sizes of the arrows depicting the transmitter fields have been adjusted in proportion to their strength).

FIG. 7 illustrates a matrix equation that is employed to calculate the transmitter weights.

FIG. 8 shows a current induced in the ground in a conductive body at location (0,−10,−4) oriented such that the dipole that represents the field points along the x axis direction, where the arrow representing this dipole at this location has been circled. The field at the surface (z=0) from this dipole has the vector components shown. A receiver array with multiple receivers laid out at the locations of the arrows would measure the shown response.

FIG. 9 is a flow chart illustrating a method of detecting the presence of a conductive body using three-component transmitters.

FIG. 10 is a system level diagram showing the components of a system that may be employed for the detection of a conductive body using an array of three-component transmitters.

FIG. 11 schematically illustrates an embodiment of a computing system for use in the system shown in FIG. 9.

FIG. 12 is a flow chart illustrating a method of detecting the presence of a conductive body using a three-component transmitter and a three-component receiver separated by an arbitrary distance, where the method involves subtracting a calculated transmitter field from the measured signal at the receiver.

FIG. 13 is a flow chart illustrating another method of detecting the presence of a conductive body using a three-component transmitter and a three-component receiver separated by an arbitrary distance, where the method involves the solution of a set of invariant equations.

FIG. 14 plots the changing geometric relationship between a three-component transmitter and a three-component receiver as a function of distance along a profile, where the offset of the receiver from the transmitter is given by the x, y and z values and the orientation of the receiver is defined by the roll, pitch and yaw in the bottom three panels.

FIG. 15 plots the rotational invariants of the total field (from the transmitter and the anomalous body) at the receiver, where, in this case, the transmitter if oriented with its z axis vertical. Most of the variation observed in the invariants is due to changes in the x, y and z offset (the invariants have units of (A/m)²).

FIG. 16 plots the rotational invariants of the total field (from the transmitter and the anomalous body) at the receiver, where, in this case, the transmitter is rotated so that its z axis is oriented along the vector joining the transmitter and receiver. As shown in the Figure, when i≠j the Hᵢ·Hⱼ terms are zero, except where there is a secondary response, in which case the term shows a non-zero anomalous response. In the case when the two vectors in the dot product are the same (i=j) there is not an anomalous response (the invariants have units of (A/m)²).

FIG. 17 plots the value of equations 28 and 29 involving combinations of the Hᵢ·Hᵢ terms, where these combinations now have a zero response away from the conductor and an anomalous response at the conductor.

### DETAILED DESCRIPTION OF THE INVENTION

As required, embodiments of the present invention are disclosed herein. However, the disclosed embodiments are merely exemplary, and it should be understood that the invention may be embodied in many various and alternative forms. The Figures are not to scale and some features may be exaggerated or minimized to show details of particular elements while related elements may have been eliminated to prevent obscuring novel aspects. Therefore, specific structural and functional details disclosed herein are not to be interpreted as limiting but merely as a basis for the claims and as a representative basis for teaching one skilled in the art to variously employ the present invention. For purposes of teaching and not limitation, the illustrated embodiments are directed to a multi-component electromagnetic prospecting apparatus and methods of detecting subsurface conductive bodies.

As used herein, the terms, “comprises” and “comprising” are to be construed as being inclusive and open ended, and not exclusive. Specifically, when used in this specification including claims, the terms, “comprises” and “comprising” and variations thereof mean the specified features, steps or components are included. These terms are not to be interpreted to exclude the presence of other features, steps or components.

As used herein, the term “exemplary” means “serving as an example, instance, or illustration,” and should not necessarily be construed as preferred or advantageous over other configurations disclosed herein.

As used herein, the terms “about” and “approximately”, when used in conjunction with ranges of dimensions of particles, compositions of mixtures or other physical properties or characteristics, are meant to cover slight variations that may exist in the upper and lower limits of the ranges of dimensions so as to not exclude embodiments where on average most of the dimensions are satisfied but where statistically dimensions may exist outside this region. It is not the intention to exclude embodiments such as these from the present invention.

As used herein, the term “aircraft” is intended to encompass any flying vehicle, including, but non-limited to, fixed-wing aircraft, rotary-wing (helicopter) aircraft, blimps, airships, unmanned airborne vehicles, balloons, and the like. When instrumentation is “carried by an aircraft” it can be attached to the aircraft or towed.

Embodiments disclosed herein provide improved electromagnetic prospecting apparatus and methods for exploring a volume of material beneath the surface of the earth, and identifying conductive bodies. Unlike known solutions, the present embodiments employ three-component transmitter and/or receivers, where three-component transmitter and receivers may be rotated (or subjected to equivalent operations) virtually via mathematical rather than physical operations.

The key feature of a three-component transmitter is that the exciting field from the transmitter is able to induce currents in a target body that has an arbitrary location and orientation.

In selected embodiments, an array of three-component transmitters is employed to generate a localized electromagnetic field at a specific orientation at a selected subsurface location. This will induce a secondary field at this specific location. Advantageously, the utilization of multiple transmitter locations focuses the field and improves the strength of the secondary field generated at a given subsurface location. Furthermore, by using three-component receivers at multiple locations, the signal-to-noise ratio of the measured signal may be further increased.

In another embodiment, a three-component dipole transmitter is employed in combination with a simple (non-gradient) three-component receiver dipole that is not a fixed (or precisely known) distance, but is separated from the transmitter by a variable distance. As shown below, when both the transmitter and receiver possess three components, the response of highly conductive bodies can be detected without knowing a-priori the precise geometric relation of the transmitter to the receiver, or holding the relative geometry between the transmitters and receivers constant. It is instead sufficient to maintain the relative orientation of each component with respect to the other two components in the transmitter (or receiver). The embodiments provided below overcome the difficulty of limited variety in coupling direction, while retaining the large signal strengths associated with a large loop survey.

Prior to describing various embodiments in detail, a heuristic introduction is provided in order to explain the principles of electromagnetic prospecting, and the relative advantages afforded by solutions provided herein. For the purposes of teaching and not limitation, the examples provided below assume that the electromagnetic transmitters and receivers are magnetic dipoles. Generally speaking, embodiments disclosed herein involve the use of dipole transmitters and receivers for the generation of electromagnetic fields and the detection of secondary electromagnetic fields that are remotely produced by conductive bodies. A magnetic dipole is generated by an antenna that typically comprises one or more loops of a conductive coil. An electric dipole is a short conductor that injects an electric field into the medium.

The formula for the magnetic field vector H(r) at a location r=(x,y,z) from a magnetic dipole located at the origin (0,0,0) is given by the following equation (Billings et al., 2010, after correction)

$$H ( r ) = \frac{M}{4 π {r}^{3}} ( 3 ( {m}^{′} + {r}^{′} ) {r}^{′} - {m}^{′} ) , \qquad ( 1 )$$

where r is the scalar distance from the dipole to the observation location r=(x²+y²+z²)^{1/2}, M is the magnitude of the dipole moment of the transmitter, m′ is the unit-vector orientation of the dipole moment, r′ is the unit vector from the dipole to the observation location, and the ′ symbol denotes a unit vector. The formula for the electric field from an electric dipole is identical except M is the electric dipole moment and there is a dielectric permittivity on the bottom line of the term out the front. If the magnetic dipole vector is oriented up the z axis, then the unit-vector orientation is m′=(0,0,1). In the case when the observation point is aligned along the axis of the transmitter dipole, then m′=r′ and m′·r′=1. This means that

$$H ( r ) = \frac{M}{4 π {r}^{3}} ( 2 {m}^{′} ) , \qquad ( 2 )$$

and the magnetic field is in the m′ direction. In the case when the observation point is in the plane that is normal to the dipole orientation and contains the dipole, then m′ and r′ are perpendicular and m′·r′=0. This means that

$$H ( r ) = - \frac{M}{4 π {r}^{3}} ( {m}^{′} ) , \qquad ( 3 )$$

and once again the magnetic field is in the m′ direction, although in this case it is pointing in the opposite (negative) direction. The magnitude is half that when the observation point is on the axis (for the same value of r). When the observation point is away from these two special locations, the orientation of the field is a linear combination of the r′ and m′ directions.

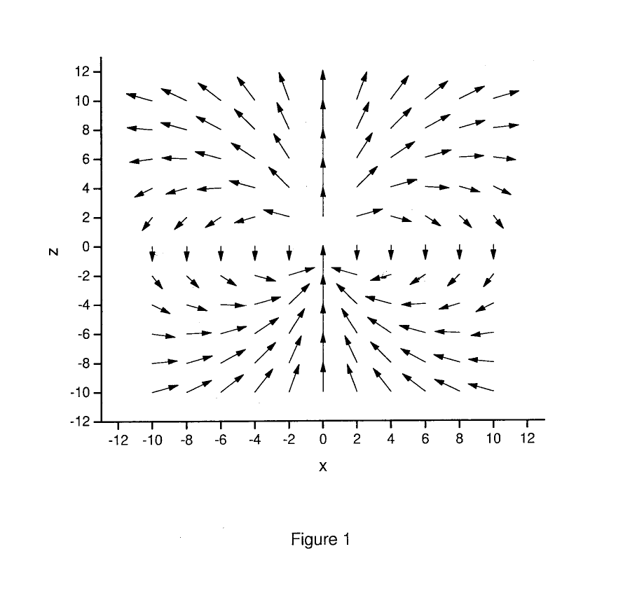

The magnetic field vectors of a dipole located at the origin and oriented up the z axis is illustrated in FIG. 1. The lengths of the arrows have been multiplied by 4πr³ so that the vectors more distant from the dipole can be seen. The field of a dipole is axially symmetric about the z axis, so this image should be rotated about the z axis to create the field in three dimensions. The locations where the field contains only a vertical component is when it is up (on the z axis) and down (on the x-y plane where z=0). In the latter case, the plane where the field is pointing down will be called the normal plane, as it is the plane that contains the dipole and is normal to the dipole orientation. At the origin the dipole field is singular. Elsewhere, the dipole field contains a non-vertical component.

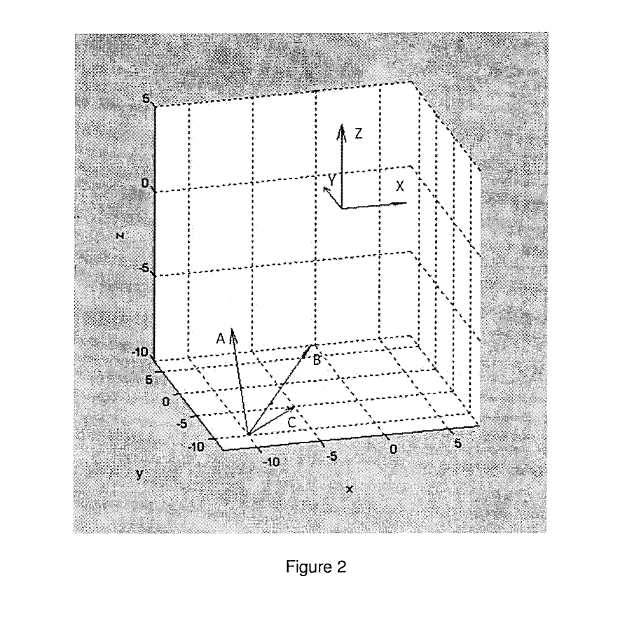

To take advantage of these properties of the dipole field, one may consider the situation where a three-component transmitter excites subsurface materials located beneath the ground. FIG. 2 shows a transmitter, which without loss of generality, can be placed at the origin. The field at a location in the subsurface at (−10, −10, −10) is shown with the three arrows A, B, and C. The field designated A, originates from the field produced by the transmitter dipole aligned along the x axis; field B is from the y-axis aligned transmitter dipole and field C is from the z-axis aligned transmitter dipole. Note that these fields are not orthogonal. Moving the location in the ground produces other fields that can be more or less orthogonal.

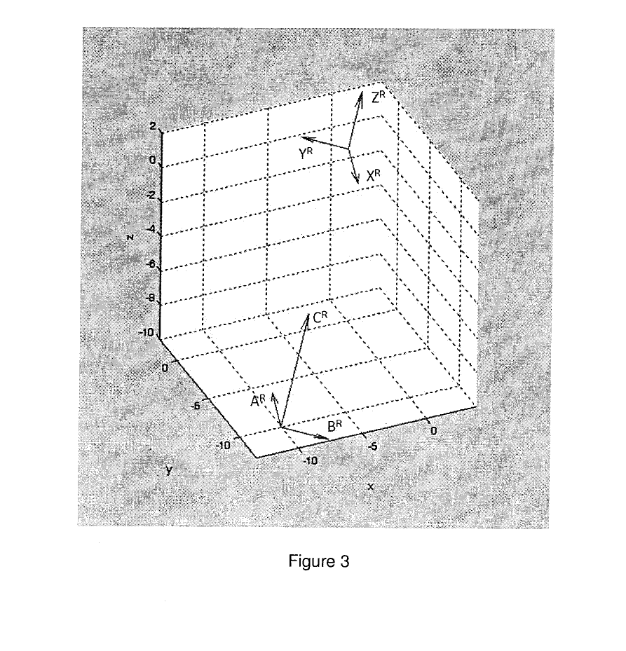

The transmitter shown in FIG. 2 has the coils rigidly aligned in an orthogonal set. The coil set can alternatively be rotated so that one of the axes lies along the axial vector from the subsurface point to the transmitter. FIG. 3 illustrates the case where the x axis is first rotated by 45 degrees around the z axis towards the y axis, and then the z axis is rotated around they axis 54.7 degrees towards the horizontal plane. This rotated transmitter set is designated X^{R} Y^{R} Z^{R} and importantly, the three fields from these transmitters A^{R}, B^{R} and C^{R} now form an orthogonal set (as can be seen in FIG. 3).

The reason for the orthogonality of the remote transmitted field is that one dipole (in this case the Z^{R} dipole) is aligned along the axial vector, so any field along the axis from this dipole will also be aligned along the axial vector. The X^{R} and Y^{R} transmitters are orthogonal to the axial vector and orthogonal to each other. The axial vector lies at the intersection of both the normal planes of the X^{R} and Y^{R} transmitters, so that the field along the axial vector from these transmitters is anti-parallel to each transmitter dipole and hence also orthogonal to the axial vector and each other.

As a result, the subsurface field on the axial vector now comprises an orthogonal set and from basic vector theory, a field at any arbitrary orientation can be constructed as a linear combination of this orthogonal set. The orthogonal set was obtained by rotating the transmitter set, but the same effect can be mathematically obtained by performing a virtual rotation by summing a linear combination of the transmitters shown in FIG. 2. For example, the Z^{R}=(0.5773, 0.5773, 0.5773)=0.5773X+0.5773Y+0.5773Z.

Similarly, as it is known that a linear combination of the transmitter dipole can be used to construct an orthogonal set at the subsurface point, it also follows that a linear combination of the original fields A, B and C can be used to construct an orthogonal set. As an example of this result, if it is desired to construct a field that points along the x (1,0,0) direction, one can solve for the coefficients x₁, x₂, x₃ that satisfy the equation

$${x}_{1} ( \begin{matrix}{A}_{1} \\ {A}_{2} \\ {A}_{3}\end{matrix} ) + {x}_{2} ( \begin{matrix}{B}_{1} \\ {B}_{2} \\ {B}_{3}\end{matrix} ) + {x}_{3} ( \begin{matrix}{C}_{1} \\ {C}_{2} \\ {C}_{3}\end{matrix} ) = ( \begin{matrix}1 \\ 0 \\ 0\end{matrix} ) , \qquad ( 4 )$$

where Aᵢ are the individual elements of the field A due to the X transmitter (similarly for Bᵢ and Cᵢ).

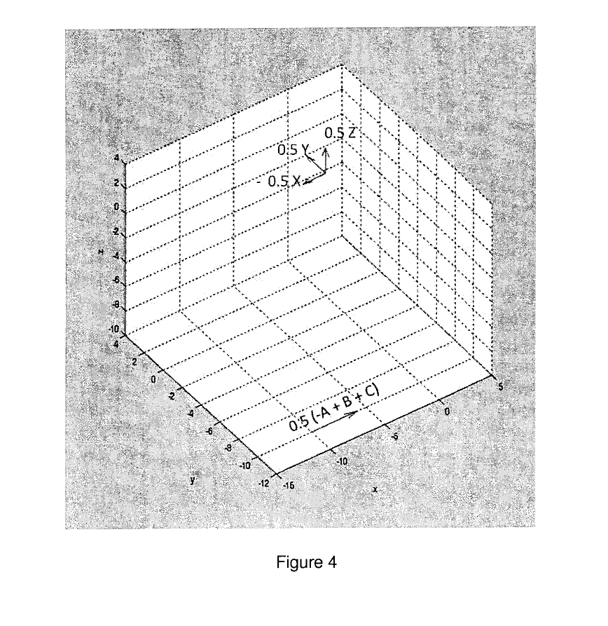

In the case of FIG. 2, one can solve this equation and obtain (x₁,x₂,x₃)=(−0.5, 0.5, 0.5). Accordingly, by multiplying the original moments of the X, Y and Z directed transmitters by these three coefficient weights directly and summing, the resultant three fields will yield the primary field in the desired (x) direction (FIG. 4). Other linear combinations of the transmitter can give the other cardinal directions, and indeed any arbitrary direction. This linear combination of orthogonal transmitter dipoles to give a directed vector in the subsurface will henceforth be referred to as a “directed transmitter”.

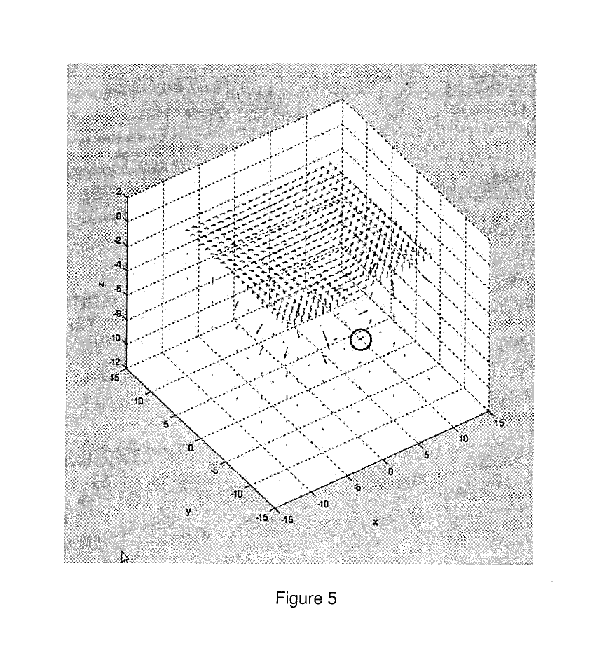

As shown above, one directed transmitter will give a directed primary field at a subsurface location. If multiple transmitters are provided and directed to give the same primary directed field, then the strength of the field at the subsurface location can be increased in proportion to the number of transmitters used. As shown in FIG. 5, multiple transmitters are all directed to generate a primary field in the x direction at location (0 −10 −4), shown by the circled vector in the Figure. Notice that the field at this location is indeed horizontal, as desired. It is noted, however, that the fields at shallower depths are larger, as a result of the fact that the field from a dipole decreases rapidly as a function of depth.

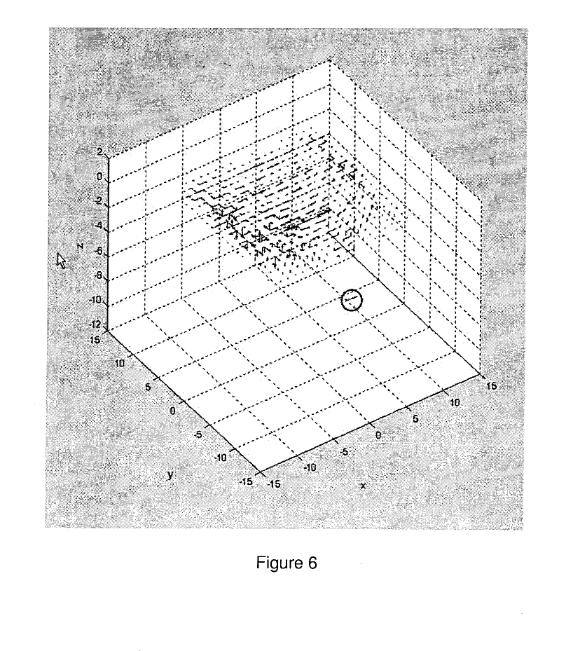

Referring now to FIG. 6, an exemplary illustration is provided, in which all the transmitter dipoles reside on the plane z=0. The length of each dipole is proportional to the weight applied to each dipole (the relative magnitude of the excitation current provided to each dipole). The subsurface field of this array is shown at a 3D grid of representative points below the surface. As prescribed, the transmitter dipole amplitudes are selected such that the only significant field is the desired horizontal field at location (0, −10, −4), again, as shown by the circled vector in the Figure. In the present example, the dipole amplitudes and transmitter rotations have been selected so that all other fields are suppressed by a factor of approximately one thousand (accordingly, these much smaller vectors are not visible in the Figure). A different linear combination of the fields produced by the transmitter dipoles could be used to focus the electromagnetic energy on any other desired location at any other desired orientation in the volume of interest.

In the exemplary case shown in FIG. 6, a large number of three-component transmitters were employed. However, if fewer transmitters are included in the array, it is expected that the ability to focus the field and/or suppress fields in other locations would be reduced. Furthermore, although the example illustrated in FIG. 6 relates to a sensing position located at the edge of the volume below the transmitter array, it is expected that improved field focusing and non-local field suppression would be achieved for a sensing position located beneath the center of the transmitter array. Preferably, the transmitters should be located such that their spacing is comparable or smaller than the size of the targets being sought and the volume being investigated is within a projection of the transmitter array plane.

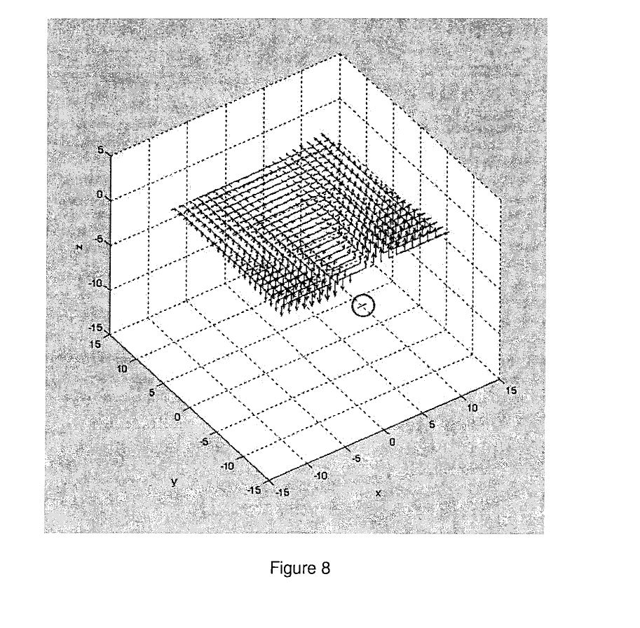

A receiver is provided to sense the secondary field radiated by a conductive feature located at the sensing location. The signal-to-noise and position sensing ability of the system may be further improved by employing an array of receivers. Further improvements will come with the use of three-component receivers, as shown in FIG. 8.

For example, using the same subsurface point as in the previous example, one may assume that a conductive body exists at that point and currents could flow in a vertical plane parallel to the y-z plane. A dipole representing these currents would be directed along the x axis (shown by the circled arrow in FIG. 8). The secondary fields from a dipole at this position would have a three-component response as shown at each receiver location in the z=0 plane (the lengths of the arrows shown at the receivers are proportional to the lengths of each individual component that would be measured). In this figure, it is assumed that the receivers that make up the receiver array are all at the same locations as the transmitters in FIGS. 5 and 6 (which they need not be).

It is expected that the use of a focused transmitter arrays and focused receiver arrays will enable the directed investigation of the subsurface at specific locations. The strong signal enhancement and noise rejection of the transmitter and receiver arrays will enable sharper resolution images and greater depth of investigation. In one embodiment, the fields detected by the array of three-component receivers may be employed to locate the position from which the secondary field originated, and to compare this sensing location to the location where the transmitted field was focused. This comparison can be useful in confirming that the detected field represents a conductive body.

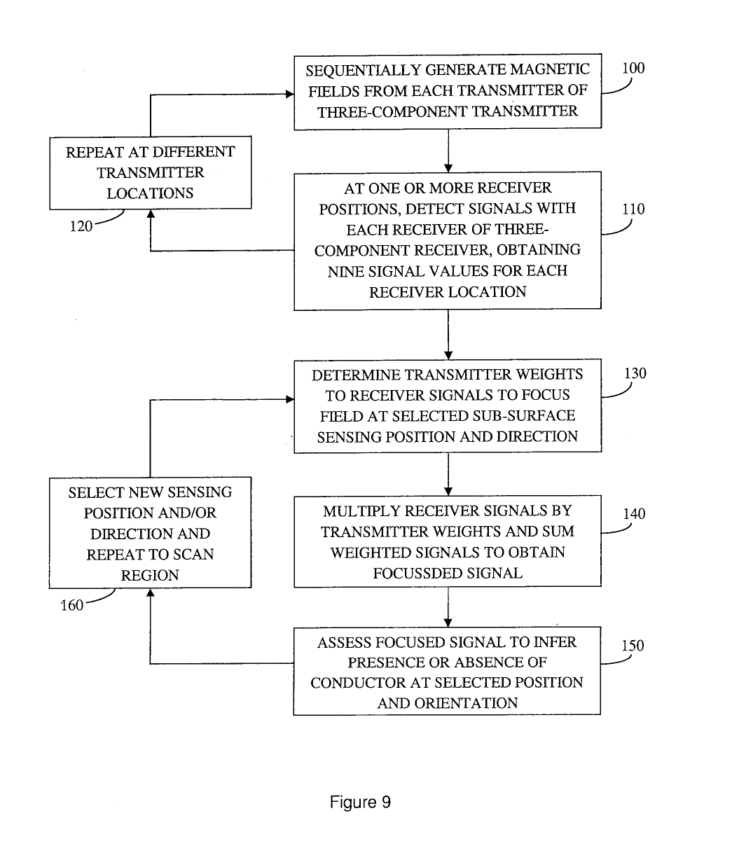

In one embodiment, aspects of the preceding examples are utilized to achieve an increase in sensitivity. As illustrated in the flow chart provided in FIG. 9, one or more three-component transmitters are employed to sequentially generate primary electromagnetic fields that probe a spatial region of interest. In step 100, each transmitter of the three-component transmitter is separately and sequentially excited. Multiple transmitters can transmit simultaneously if multiplexed in the frequency domain as described below. In step 110, a three-component receiver is provided to individually detect, with each receiver of the three-component receiver, secondary electromagnetic fields produced in response to the electromagnetic fields from the three transmitter dipoles. Accordingly, nine separate signals are obtained by the three-component receiver. This process is repeated, as shown at step 120, for multiple transmitter locations to obtain receiver signals, for each component in the three-component receiver, that are obtained for each transmitter of the three-component transmitter at multiple locations near the region to the region of interest.

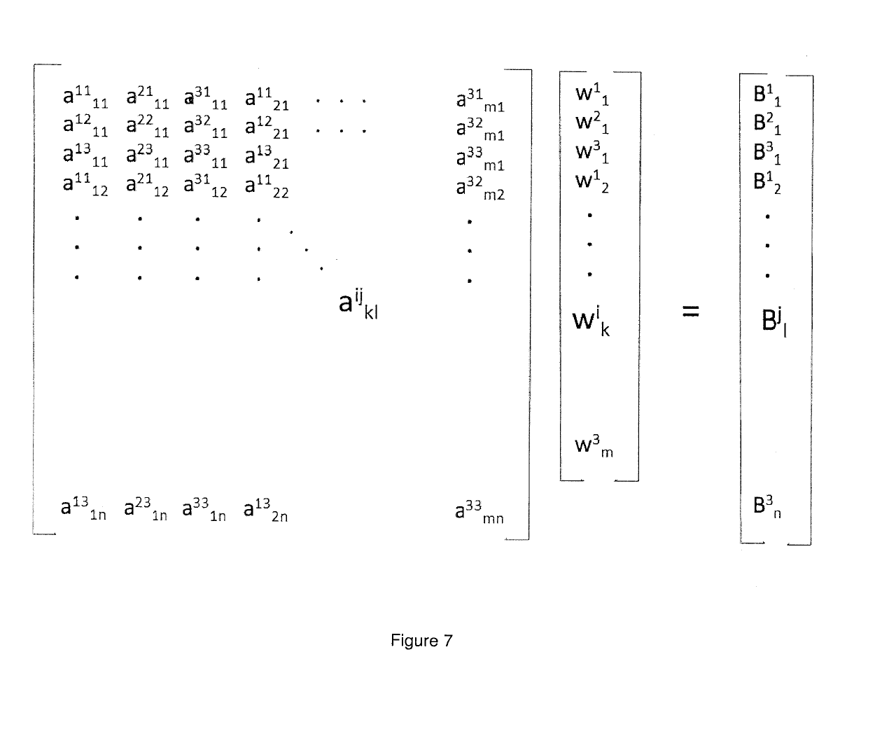

The principle illustrated graphically in FIG. 6 and mathematically in FIG. 7 may then be employed to post-process the receiver signal data in order to obtain a focused signal at a selected position. This is because the signal response detected with the three-component receiver varies in a linear manner with the transmitter signal and a linear combination of transmitter dipole strengths may be employed as a post-processing step to effectively focus the transmitter field at a specific location and orientation. As shown in step 130, the post-processing is performed by determining the weights associated with each transmitter that may be multiplied with the corresponding individual receiver signals such that the sum over all the weighted transmitters is used to obtain a signal at each receiver position. This sum over transmitters is intended to provide enhanced directional sensitivity to a selected subsurface position and direction, while substantially suppressing the sensitivity of the receiver to other subsurface positions. This weighted sum is obtained in step 140, for each component of the three-component receiver, thereby generating a focused signal at the selected position and direction. The focused signal improves the signal at the desired subsurface location relative to other locations. If a conductive feature is present at the desired subsurface sensing location, then currents induced in the ground at that location may be detected with improved signal to noise. As shown at step 150, the focused signal may therefore be assessed to infer the presence or absence of a conductor with enhanced sensitivity.

The preceding steps produce an enhanced signal response and sensitivity at a specific position and direction. In order to probe other directions and/or positions, the post-processing may be repeated, as shown at step 160. Advantageously, this may be performed at any time after having gathered the receiver data, and does not require additional measurements.

The values for the weights applied to the transmitter each can be determined by solving a matrix equation. A matrix is constructed that contains the predicted fields from each transmitter at each subsurface location in three orthogonal orientations. Each row represents the field in the x, y or z orientation at one of the subsurface locations (three rows for each subsurface location) and the columns are the fields from a different transmitter (three dipole orientations means three columns for each transmitter location). These matrix elements are multiplied by the vector that contains the strength of the field of each transmitter dipole (three vector elements for the three dipoles at each location). The right-hand-side vector is the field at each location in the three subsurface orientations for the sum of all the transmitter dipoles at the different transmitter locations.

This matrix equation is illustrated in FIG. 7. The transmitter weights are wⁱₖ, where i denotes the orthogonal directions (1, 2 or 3) of the dipole and k is the index for the transmitter location (k=1,m). The field at the subsurface location is B^{j}₁ where j is the orthogonal direction (1, 2 or 3) and l denoles the subsurface location (l=1,n). The matrix elements are a^{ij}ₖₗ which is the field from a transmitter dipole is the ith orientation and the kth transmitter location at the subsurface location l in the subsurface orientation j.

To determine the transmitter weights for the subsurface sensing position, set all elements in the right-hand-side vector to zero, except at the one desired location and orientation, and then invert the matrix to solve for the transmitter weights. These transmitter weights are then applied to the receiver signals that correspond to that transmitter dipole at that transmitter location.

The measurements at different transmitter locations may be performed by providing an array of three-component transmitters at known locations spanning a region. However, since the transmitters are activated sequentially (or multiplexed in the frequency domain), a single transmitter or a partial transmitter array may be physically translated to the various transmitter locations, provided that the locations and orientations are recorded. The relative locations and orientations may be determined using a position sensing system, such as a global positioning system, and optionally an orientation sensing device such as a compass and spirit level or a gyroscopic device.

In another embodiment, the receiver signals may be collected at more than a single receiver location in order to take advantage of the principle illustrated in FIG. 8. As in the case of the transmitter array, these receivers may be employed to produce a detected signal from a linear combination of receivers; one linear combination could be used for one subsurface position and direction and another linear combination for another position and direction. The weights in these linear combinations could be set in many ways. One way is to make the weights large when the field from a dipole target at the specified location (and orientation) is large.

In one embodiment, the focused signal calculated based on the receiver signals could be compared (e.g. cross correlated) with the theoretical field from a dipole at the subsurface location and orientation of interest (i.e. the theoretical fields in FIG. 8). If the correlation coefficient exceeds some threshold, then it is more likely that there is a conductive feature at the location of interest. It is noted that the sensitivity and position sensing ability of the receiver array is dependent on the number of receivers employed in the array.

As noted above, the sensitivity is enhanced at the position of interest by weighing and summing the measured response signals with weighting functions that are mathematically obtained to give a non-zero sum when the source of the field is at the desired location and orientation (for substantially co-located receivers). This effectively enhances the field detected from the sensing location, and suppresses the detection of fields from other subsurface locations. These weighting functions are the same functions used to focus the transmitter at the desired location (e.g. FIG. 6) and are determined using the matrix inversion procedure described above. Using the principle of reciprocity in electromagnetics, a dipole at any of the non-target locations in the subsurface will give a zero sum after multiplying by these weights and adding. The sum of the fields from a body at the target location will be non zero.

In another embodiment, post-processing is employed, but using a method that does not involve transmitter and receiver weighting. Instead, the large data set provided by the three component transmitters and multiple receivers is employed to solve a large inverse problem. For example, the magnitude of the subsurface conductive body could be unknowns and these unknowns could be estimated by using linear inversion techniques to find the dipole magnitudes that are consistent with the response measured in all the transmitter/receiver combinations.

The data obtained according to the above embodiments could also be used as input to standard techniques used in geophysical interpretation. For example, non-linear inversion techniques are well known, such as Cox et al. (2010) and Oldenburg et al. (2010), for estimating a conductivity structure that is consistent with the measured data. The additional data provided by the multiple three-component transmitters and the receiver array would provide more data for better constraining the inversion, providing a better result.

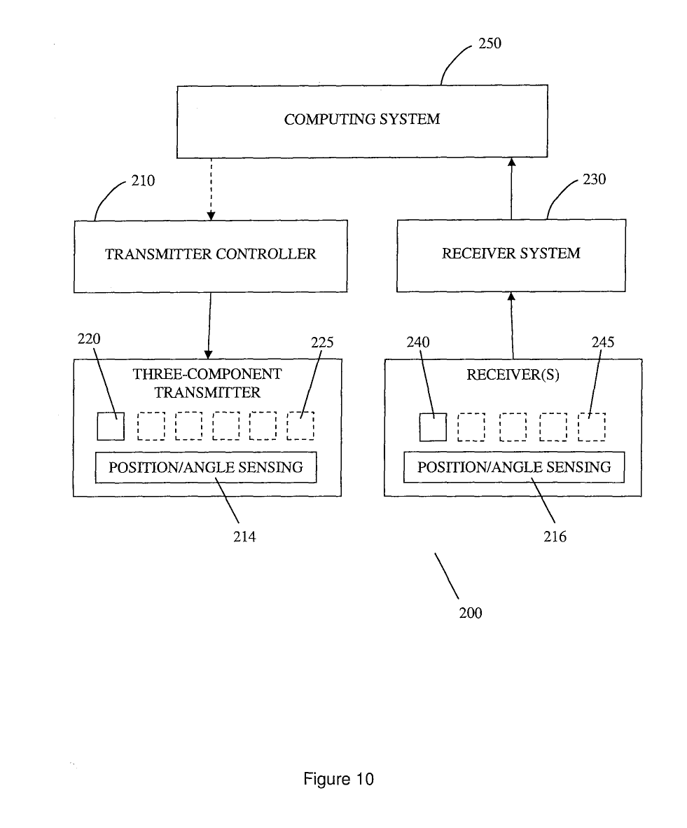

FIG. 10 provides a schematic illustration of the equipment used to acquire the data. System 200 includes the transmitter controller (210) and one or more three component transmitters 220. As noted above, the three-component transmitter 220 may be physically translated to the different transmitter locations 225, or an array of three-component transmitters may be provided such that one three-component transmitter is provided at each of the different locations 225. Transmitter controller 210 includes electronics for driving the transmitters (transmitters may be industry standard dipole transmitters). Transmitter controller 210 is configured to electrically drive each transmitter of each three-component transmitter with a continuous current (the current is either held constant or if it changes, the specific values are recorded so that the effect of changes can be removed in later processing). Each component in each transmitter transmits separately and/or distinctly, such that its signal may be uniquely detected, by multiplexing in the time-domain or the frequency-domain as described below. Each transmitter can be received by a single receiver component or a multiplicity of receivers and receiver components.

System 200 further includes a receiver system 230 comprises one or more receivers 240 for detecting a secondary electromagnetic field radiated by a conductive body located at the sensing location. Receivers are preferentially three-component receivers, but in selected embodiments may comprise a single- or dual-component receiver. As shown, an array of three-component receivers 245 may be provided for enhanced sensitivity. The array of receivers (245) can be build up either by using a single receiver and moving it sequentially to all locations (240) for each transmitter position, or multiple receivers (245) at multiple locations moved so as to cover the whole area.

System 200 further comprises position and angle sensing devices 214 and 216 for recording the position and orientation of the three-component transmitter 220 and three-component receiver 240, respectively. The position sensing device may be, for example, a global positioning system (GPS) receiver, and the orientation sensing device may be a compass and spirit level or a gyroscopic device. Note that there is no connection between the transmitter and receiver, except that they must be synchronized to a common clock. This may be performed using industry standard techniques, such as GPS synchronization, crystal clocks, or a radio link.

As shown in FIG. 10, the system may be controlled and/or interfaced with computing system 250, which performs the processing steps outlined above for determining the weights, solving the inversion problem, determining the timing of the driving of the transmitters, and/or controlling the positioning of the three-component transmitters. In one embodiment, computing system 250 is programmed with locations and orientations of transmitters 220, and calculates appropriate weights for each transmitter location within array 225 in order to generate the required virtual rotations and amplitudes for obtaining a focused electromagnetic field at a given sensing location, and substantially suppressed field values in neighbouring locations. Computing system 250 then applies the transmitter weights to the individual receiver signals and calculates the vector sum of all the weighted receiver signals, as described in FIG. 9.

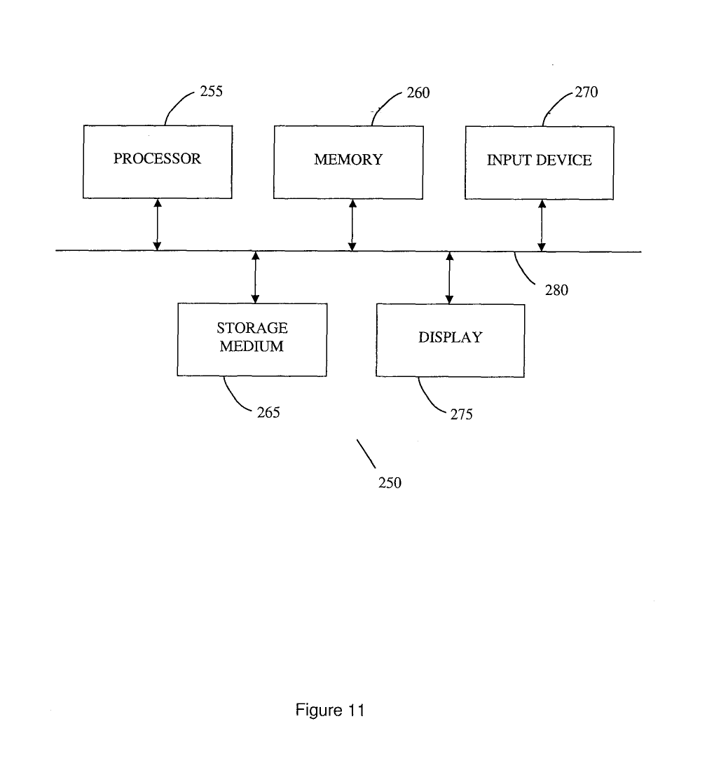

An example of computing system 250 is illustrated schematically in FIG. 11. Computing system 250 can be, for example, desktop computer, workstation, laptop computer, smartphone, or any other similar device having sufficient memory, processing capabilities, and input and output capabilities to implement the embodiments described herein. The device can be a dedicated device used specifically for implementing the method or a commercially available device programmed to implement the method.

Once the data from the multiplicity of transmitter receiver combinations have been collected, they can be processed to reveal the subsurface structure. This can be done in a multiplicity of ways as described above. As shown in FIG. 11, computing system 250 preferably contains a processor 255, a memory 260, a storage medium 265, an input device 270, and a display 275, all communicating over a data bus 280. Although only one of each component is illustrated, any number of each component can be included. For example, computing system 250 may include a number of different data storage media 265.

The processor 255 executes steps of the aforementioned method under the direction of computer program code stored within computing system 250. Using techniques well known in the computer arts, such code is tangibly embodied within a computer program storage device accessible by the processor 255, e.g., within system memory 260 or on a computer readable storage medium 265 such as a hard disk, CD ROM or flash memory. The methods can be implemented by any computing method known in the art. For example, any number of computer programming languages, such as Java and C++, can be used. Furthermore, various programming approaches such as procedural or object oriented can be employed. In cases when the transmitter array is constructed by sequentially moving the transmitter from one location to the other, the transmitter can be carried by any of a number of suitable methods, such as manually transported by an operator, transported in a ground-based vehicle, or transported within or connected to an airborne vehicle. The receiver could also be moved by any of these different methods, with the transmitter and receiver being movable according to any combination of these methods.

In one embodiment, multiple receivers reside on the ground and the transmitter is moved over all the locations of the survey area (using ground or airborne transportation). In another embodiment, the transmitter resides at one location on the ground and the receiver is moved across the survey area using a ground or airborne vehicle. The transmitter is then moved to a different position and then the whole survey area is again covered by moving the receiver.

Both transmitter and receivers could be airborne, but care would be required to ensure all transmitter and receiver combinations are covered and the airborne vehicles do not collide. This might be possible with a large slow moving vehicle such as a blimp carrying the transmitter slowly across the survey area and smaller unmanned vehicles carrying the receivers. Those skilled in the art will appreciate that there are additional suitable methods of acquiring the data. Note that transmitters and receivers can also be placed in boreholes below the ground surface. Combinations of receivers or three-component transmitters in boreholes and three-component transmitters and/or receivers on the ground and/or in the air are also possible.

While it is preferable from a practicality standpoint for the locations of the transmitters in the array to be co-planar, it is to be understood that the embodiment may be practiced with non-planar transmitters, provided that the spatial relationship and orientation among multiple transmitters remains known and/or controllable.

Although the transmitter array has been described as an array of three-component transmitters, it is to be understood that the dipoles forming a given three-component transmitter triplet need not be precisely spatially centered in space. For example, small variations in the relative positioning of the dipoles forming a three-component transmitter of the transmitter array will not strongly affect the focusing of the field at a location that is distant from the array (i.e. provided that the distance between the transmitter and the sensed location is very large relative to the separation of the dipoles forming the transmitter).

After having recorded secondary fields detected by the receiver (or receiver array) over a given region or volume, the results can be analyzed to infer the presence or absence of conductive bodies. In one non-limiting example, the results from a scan can be displayed on a user interface where the individual scanned volume elements (voxels) can be coloured (or otherwise distinguished, for example, shaded) according to the intensity of the response from the focused transmitter/receiver arrays. In another example, vectors could be plotted at the subsurface location in proportion to the response from the focused transmitter/receiver array. Alternatively, normal planes to the vectors could be plotted, as these represent the current flow paths in conductive features.

In other embodiments disclosed below, apparatus and methods are provided for the detection of conductive bodies involving a single three-component transmitter and a single three-component receiver, where geometrical relationships are employed to enable the detection of extremely conductive bodies without requiring that the distance between the transmitter and receiver be known or fixed.

The traditional method for detecting extremely conductive bodies is to examine the detected secondary field for a temporal response that is essentially identical in shape and timing (in phase) with the transmitter response. However, it is difficult to distinguish the in-phase secondary field produced by the conductor from those produced by the transmitter, as they have a substantially identical waveform shape and timing.

Provided that the geometric relation between the transmitter and receiver is known precisely, then the amplitude of the in-phase field from the transmitter can be predicted and removed. What is left is the field from the extremely conductive body in the subsurface. Known methods have applied this principle for the detection of conductive bodies, where the spatial relationship and relative distance of the transmitter and receiver are known and fixed in position and orientation.

In contrast to these known methods, the forthcoming embodiments employ three-component-dipole transmitters and receivers where the in-phase field from the transmitter can be identified without knowing or fixing the distance between the transmitter and receiver. This is instead achieved by maintaining a virtual orientation of the transmitter with respect to the receiver, and taking advantage of geometric aspects of the transmitted field at the receiver location.

For example, if the three-component transmitter dipole is rotated so that one transmitter has its axial vector intersecting the receiver location, then the three fields from the three component transmitter will all be orthogonal. As shown above with reference to equations (1) to (3), the axial field will be twice as large as the two transverse fields. As this property is true along the axis intersecting the transmitter and receiver locations, it is not necessary to know a-priori the distance of the transmitter to the receiver.

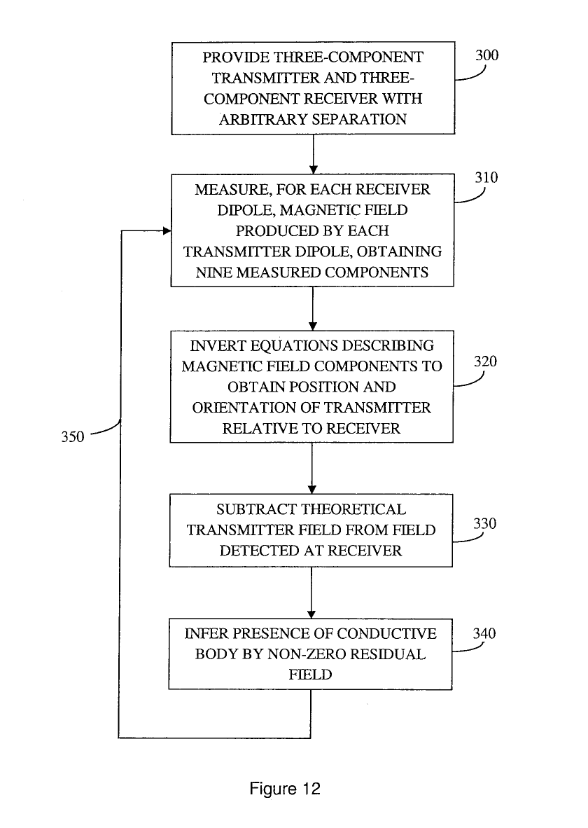

Accordingly, a number of embodiments are henceforth described in which this principle is employed for the sensitive detection of conductive bodies. In one embodiment, as shown in FIG. 12, the measured magnetic field components are employed to infer the position and orientation of the receiver.

In step 300, the three-component transmitter and receiver are provided at an arbitrary separation (such that the receiver is sufficiently close to detect a secondary field produced by a conductive body in response to a primary field generated by the transmitter). The magnetic field components are then measured by the three-component receiver in step 310. Nine components are measured: the magnetic field for each transmitter dipole (3) measured for each receiver dipole (3).

In step 320, the equations describing the nine components are then inverted using a non-linear iterative method to estimate a posteriori the orientation and position of the receiver with respect to the transmitter. The nine equations are derived from equation (1). There are three transmitters, in the x, y and z directions (in the coordinate system of the transmitter), so m is (1,0,0), (0.1,0) and (0,0,1) respectively. This gives three equations for the three magnetic fields. These three fields are then rotated by the roll pitch and yaw of the receiver, giving the fields measured at the receiver. As each field is a three component vector, this gives nine scalar equations. There are six unknowns: the offsets from the transmitter to the receiver in the, x, y and z directions and the roll pitch and yaw of the receiver.

This inversion may be achieved by adjusting the relative orientation and position of the receiver with respect to the transmitter until the fields calculated using equation (1) are close to the measured fields. There are many algorithms for doing this adjustment; the Levenberg-Marquardt algorithm in Press et al., (1992) is one method known for achieving the inversion.

Having estimated the orientation and position of the receiver, the primary fields are calculated and subtracted from the measured fields in step 330. The remaining residual field is then assessed in step 340, and a substantially non-zero residual is indicative of conductive bodies in the subsurface. The steps may then be repeated for different locations, as shown by 350, to investigate and/or scan other spatial regions.

In another embodiment, one or more invariant terms are calculated based on the measured field components, and the invariant terms are assessed to infer the presence of a conductive body. In particular, some vector quantities measured at the receiver are independent of the orientation of the receiver and hence the coordinate system used to measure the vectors.

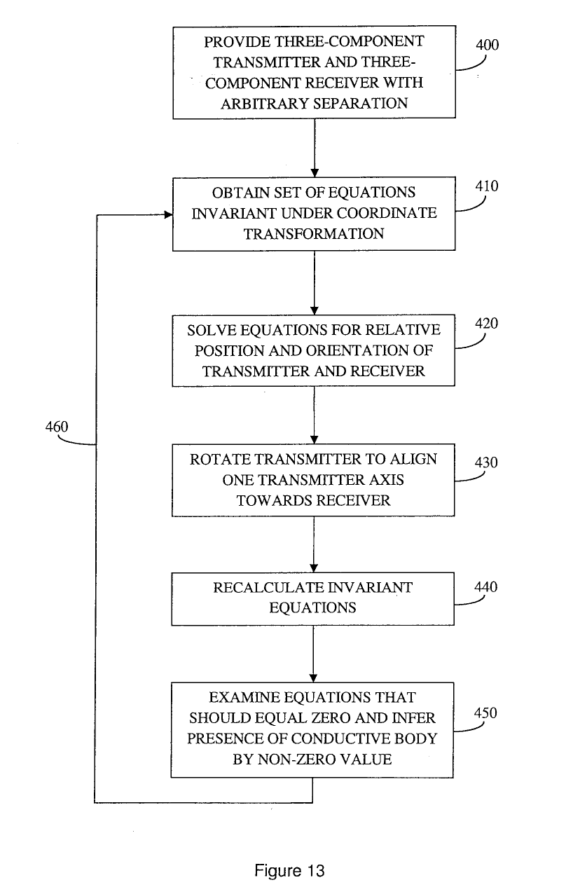

FIG. 13 provides a flow chart that illustrates the steps that may be followed to perform the present embodiment. In step 400, a three-component transmitter and a three-component receiver are provided at an arbitrary separation. A set of invariant equations for the magnetic field of the transmitter at the location of the receiver are obtained in step 410, where the equations are invariant under a change in the coordinate system. For example, the following are invariant under a change of coordinate system, the dot products of two fields Hᵢ×Hⱼ, the magnitude of the cross product of two fields Hᵢ×Hⱼ and the scalar product of three fields. In the following Hₓ, H_{y} and H_{z} are the vector fields measured at the receiver from the transmitter dipoles oriented in the x, y and z directions (where these directions are in the coordinate frame of the transmitter). For the three-component receiver, the formulae for these quantities are

$$\begin{matrix} {H}_{x} + {H}_{x} = \frac{{M}_{x} {M}_{x}}{{( 4 π {r}^{3} )}^{2}} ( \frac{3 {x}^{2}}{{r}^{2}} + 1 ) , & ( 5 ) \\ {H}_{x} + {H}_{y} = \frac{{M}_{x} {M}_{y}}{{( 4 π {r}^{3} )}^{2}} ( \frac{3 xy}{{r}^{2}} ) , & ( 6 ) \\ {H}_{x} + {H}_{z} = \frac{{M}_{x} {M}_{z}}{{( 4 π {r}^{3} )}^{2}} ( \frac{3 xz}{{r}^{2}} ) , & ( 7 ) \\ {H}_{y} + {H}_{y} = \frac{{M}_{y} {M}_{y}}{{( 4 π {r}^{3} )}^{2}} ( \frac{3 {y}^{2}}{{r}^{2}} + 1 ) , & ( 8 ) \\ {H}_{y} + {H}_{z} = \frac{{M}_{y} {M}_{z}}{{( 4 π {r}^{3} )}^{2}} ( \frac{3 yz}{{r}^{2}} ) , & ( 9 ) \\ {H}_{z} + {H}_{z} = \frac{{M}_{z} {M}_{z}}{{( 4 π {r}^{3} )}^{2}} ( \frac{3 {z}^{2}}{{r}^{3}} + 1 ) , & ( 10 ) \\ {H}_{x} \cdot ( {H}_{y} \times {H}_{z} ) = \text{?} & ( 11 ) \\ \vert {H}_{x} \times {H}_{y} \vert = \frac{{M}_{x} {M}_{y}}{{r ( 4 π {r}^{3} )}^{2}} \sqrt{4 {x}^{2} + 4 {y}^{2} + {z}^{2}} , & ( 12 ) \\ \vert {H}_{x} \times {H}_{z} \vert = \frac{{M}_{x} {M}_{z}}{{r ( 4 π {r}^{3} )}^{2}} \sqrt{4 {x}^{2} + {y}^{2} + 4 {z}^{2}} , & ( 13 ) \\ \vert {H}_{y} \times {H}_{z} \vert = \frac{{M}_{y} {M}_{z}}{{r ( 4 π {r}^{3} )}^{2}} \sqrt{{x}^{2} + 4 {y}^{2} + 4 {z}^{2}} , \\ \text{?} \text{indicates text missing or illegible when filed} & ( 14 )\end{matrix}$$

The invariants on the right-hand side can be measured as can the moments of each of the transmitters Mₓ, M_{y} and M_{z}, so the only unknowns are x, y and z. These equations are then solved in step 420 to obtain the relative position and orientation of the transmitter and receiver. There are 10 equations and three unknowns, so there are many ways to solve these equations to find the unknowns.

A simple method involves employing equation (11) to estimate r=(x²+y²+z²)^{1/2}, and then equations (5), (8) and (10) to estimate x, y and z respectively. The above method provides a non-limiting example in which the position and orientation of the transmitter may be determined. However, it is to be understood that other suitable methods may be employed, such as the orthogonal Procrustes rotation method (Golub and Van Loan, 1996; Key and Lockwood, 2010), which can be used to estimate rotation angles.

Having determined the relative position between the transmitter and receiver, the axial direction is now known. Accordingly, the transmitter orientation can be rotated in step 430 so one transmitter (say the z directed transmitter) is aligned along the axial direction (the transmitter can point towards or away from the receiver). The rotation can either be a real rotation, or a virtual mathematical rotation, as described above.

In the new coordinate frame of the transmitter, the receiver location is now r=(0,0,z) and the above equations become

$$\begin{matrix} {H}_{x} + {H}_{x} = \frac{{M}_{x} {M}_{x}}{{( 4 π {z}^{3} )}^{2}} , & ( 15 ) \\ {H}_{x} + {H}_{y} = 0 , & ( 16 ) \\ {H}_{x} + {H}_{z} = 0 , & ( 17 ) \\ {H}_{y} \cdot {H}_{y} = \text{?} , & ( 18 ) \\ {H}_{y} \cdot {H}_{z} = 0 , & ( 19 ) \\ {H}_{z} \cdot {H}_{z} = 4 \frac{{M}_{z} {M}_{z}}{{( 4 π {z}^{3} )}^{2}} , & ( 20 ) \\ {H}_{x} \cdot ( {H}_{y} \times {H}_{z} ) = \frac{2 {M}_{x} {M}_{y} {M}_{z}}{{( 4 π {z}^{3} )}^{3}} , & ( 21 ) \\ \vert {H}_{x} \times {H}_{y} \vert = \text{?} & ( 22 ) \\ \vert {H}_{x} \times {H}_{z} \vert = \frac{2 {M}_{x} {M}_{z}}{{( 4 π {z}^{3} )}^{2}} , & ( 19 ) \\ \vert {H}_{y} \times {H}_{z} \vert = \frac{2 {M}_{y} {M}_{z}}{{( 4 π {z}^{3} )}^{2}} . \\ \text{?} \text{indicates text missing or illegible when filed} & ( 23 )\end{matrix}$$

These eleven invariants may be recalculated in step 440, and the cross terms of the dot products (equations 16, 17 and 19) should all be zero. These equations, which should equal zero, are assessed in step 450 to determine whether or not their computed values are nonzero. If a substantially non-zero result is obtained, then it may be inferred that a conductive body is present. The steps may then be repeated for different locations, as shown by 460, to investigate and/or scan other spatial regions.

Also, the relative size of each of the non-zero terms is known from equations 15, 18, 20-23, so that the following quantities should be zero if there is no conductor present:

$$\begin{matrix} 2 \vert {H}_{x} \times {H}_{y} \vert - \text{?} \vert {H}_{x} \times {H}_{z} \vert = 0 , & ( 24 ) \\ 2 \vert {H}_{x} \times {H}_{y} \vert - \text{?} \vert {H}_{y} \times {H}_{z} \vert = 0 , & ( 25 ) \\ \vert {H}_{x} \times {H}_{z} \vert - \text{?} \vert {H}_{y} \times {H}_{z} \vert = 0 , & ( 26 ) \\ 4 \vert {H}_{x} \times {H}_{y} \vert - \frac{{M}_{y}}{{M}_{z}} \vert {H}_{x} \times {H}_{z} \vert - \frac{{M}_{x}}{{M}_{z}} \vert {H}_{y} \times {H}_{z} \vert = 0 , & ( 27 ) \\ 4 {H}_{x} \cdot {H}_{x} - \frac{{M}_{x}^{2}}{{M}_{z}^{2}} {H}_{z} \cdot {H}_{z} = 0 , & ( 28 ) \\ 4 {H}_{y} \cdot {H}_{y} - \text{?} {H}_{z} \cdot {H}_{z} = 0 , & ( 29 ) \\ {H}_{x} \cdot {H}_{x} - \frac{{M}_{x}^{2}}{{M}_{y}^{2}} {H}_{y} \cdot {H}_{y} = 0 , & ( 30 ) \\ {H}_{z} \cdot {H}_{z} - 2 \frac{{M}_{z}^{2}}{{M}_{x}^{2}} {H}_{x} \cdot {H}_{x} - 2 \frac{{M}_{z}^{2}}{{M}_{y}^{2}} {H}_{y} \cdot {H}_{y} = 0. \\ \text{?} \text{indicates text missing or illegible when filed} & ( 31 )\end{matrix}$$

There is a large number of other combinations could also be constructed that sum to zero, including for example combinations which include the scalar triple product (equation 21).

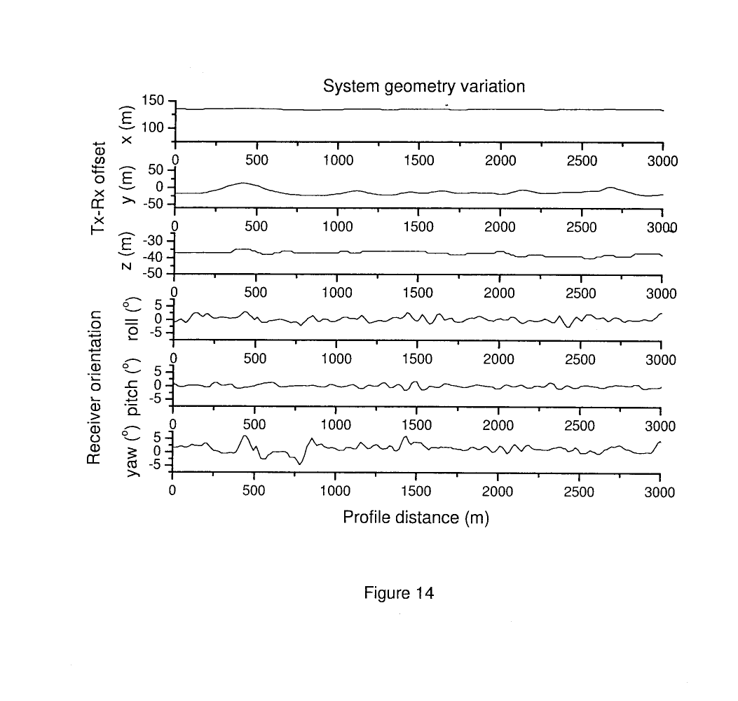

The procedures described above assume that the secondary field from the conductor does not distort the estimates of r and x, y and z. This is normally a good approximation for deep conductors, as demonstrated in the following example. The example involves a three-component transmitter, and the effect of changing x, y and z offsets of the receiver (Rx) from the transmitter (Tx) are shown in FIG. 14 as a function of distance along survey line or “profile” traversed by a system comprising a transmitter and receiver. Also shown in FIG. 14 is the change in orientation of the receiver coil as it moves along the profile. The transmitter is assumed to have its z axis oriented vertically. (A non-vertical z transmitter is equivalent to a different x, y and z offset.)

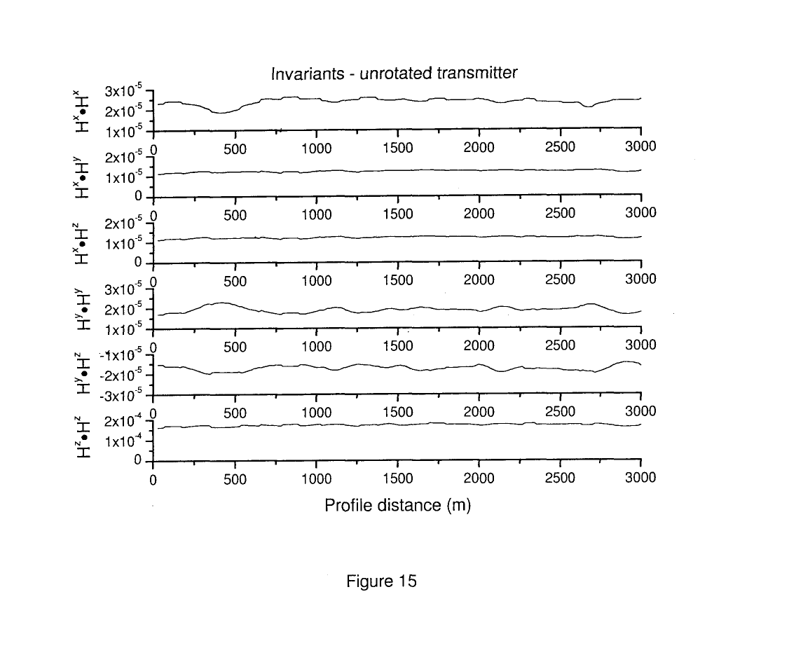

The primary field at the receiver was then calculated at each location. Also, the secondary field from a sphere of radius 50 m buried 50 m below the ground surface was calculated and added to the primary field. The rotational invariants were then calculated and plotted on FIG. 15. Note that the lateral changes in the invariants along the profile are largely a function of the changes in transmitter-receiver offset—there is no secondary field apparent on the profiles.

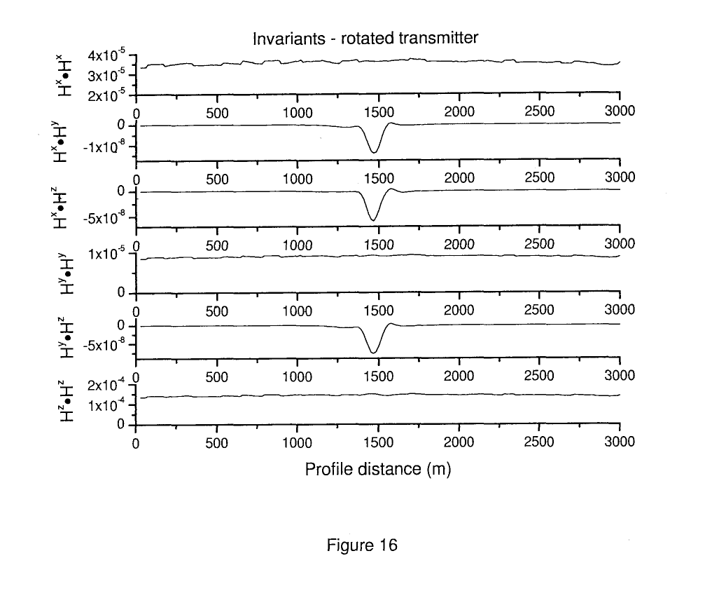

The values of the invariants at each location were then used to estimate the offsets x, y and z using a non-linear inversion routine. Then, the three-component transmitter was mathematically rotated so that the axis of the z component dipole lies along the line joining the transmitter and receiver. The invariants in this situation are shown on FIG. 16. Note that the dot products Hᵢ·Hⱼ for the cases when i≠j have a zero response away from the conductor and an anomalous (non-zero) response over the conductor at location 1500 m. The dot products Hᵢ·Hⱼ for the cases when i=j are not zero, their magnitude is a function of r and the dipole moment.

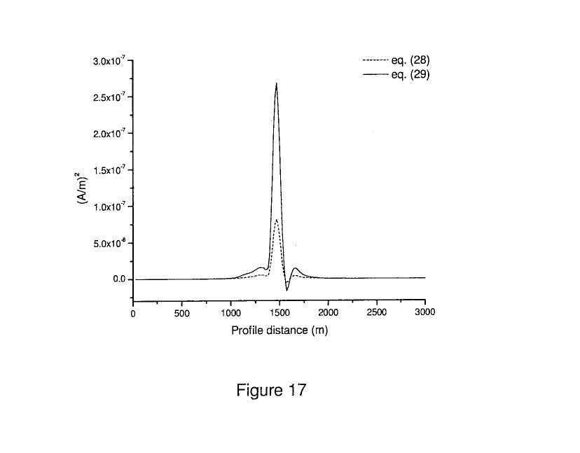

Using equations 28 and 29 as an example, one can also calculate a quantity which is zero where there are no conductors present, and which is anomalous where there is a conductor (FIG. 17). If the secondary field from the conductor is distorting the estimates of the offsets x, y and z, it is not hindering the ability of the method to identify where there is a conductor and where there is not one.

If procedures equivalent to the above are applied to the in-phase and quadrature components of the response and a conductive body in the subsurface is recognized in the in-phase component and not the quadrature component, then it can be clearly identified as an extremely conductive body.

The three transmitters can be utilized in a time-domain multiplexed format, or may transmit independent frequencies simultaneously. In the time-domain multiplexed format, each transmitter is activated in turn with the other two transmitters switched off. For time-domain waveforms, the simultaneous transmission option would involve transmitting at base frequencies which had harmonics that interleave (e.g. a triplet of base frequencies at 1 Hz, 2 Hz, and 4 Hz has sets of harmonics at the following frequencies 3, 5, 7, . . . Hz; 6, 10, 14, . . . Hz and 12, 20, 28, . . . Hz so there is no overlap). This could also be called frequency-domain multiplexing.

In practice, a set of frequencies that does not have any harmonics at power-line frequencies would be chosen. In North America, where the power-line frequency is 60 Hz, this could be 1.5625 Hz, 3.125 Hz and 6.25 Hz for example. This process would allow the data to be collected three times faster, but the disadvantage is that in order to combine the results from the individual transmitter dipoles, it would be necessary to interpolate the data from all transmitters to a common frequency so that linear combinations of the results data from each transmitter could constructed.

The foregoing embodiments exploit the unique properties of three-component transmitters and receivers. It is noted, however, that the dipoles need not be exactly orthogonal. Just as a linear combination of different dipoles can effectively rotate the transmitter, a linear combination of dipoles that are not exactly orthogonal can be used to construct a linear combination that is orthogonal.

This can be achieved provided that all three transmitter dipoles do not lie in the same plane. The specific linear combination required to achieve orthogonality would be unique to each three-component set and could be determined as part of a calibration procedure once each set is constructed. Note that the set must be rigid, so that each time the relative angles between the dipoles change, the calibration procedure must be repeated. As described above, the orthogonality of the physical dipoles is not necessary, as a virtual orthogonal set can be constructed mathematically.

It is also to be understood that the embodiments may be practiced without purely dipole fields. Those skilled in the art will appreciate that non-dipole fields generated with relatively small loops can be considered to be dipolar fields at sufficiently large distances from the transmitter. Accordingly, provided that the receiver is about 5-10 times further away from the transmitter as the radius of the transmitter loop, then the field of the transmitter at the receiver could be very well approximated by a dipole field.

As noted with regard to the previous embodiment, although the transmitter array has been described as an array of three-component transmitters, it is to be understood that the dipoles forming a given three-component transmitter triplet need not be precisely spatially centered in space. For example, small variations in the relative positioning of the dipoles forming a three-component transmitter of the transmitter array will not strongly affect the focusing of the field at a location that is distant from the array (i.e. provided that the distance between the transmitter and the sensed location is very large relative to the separation of the dipoles forming the transmitter).

While the foregoing embodiments have been illustrated in terms of airborne detection, it is to be understood that the scope of the embodiments is not intended to be limited to airborne excitation and/or reception of fields. Indeed, the transmitters and/or receivers may be in the air, on the ground surface, in boreholes, underground, or a combination thereof. The transmitters and receivers need not be a fixed distance from each other, and may be separated by an arbitrary distance.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

### REFERENCES

Annan, A. P., 1986, Development of the PROSPECT I airborne electromagnetic system, in Palacky, G. J., (Ed), Airborne resistivity mapping. Geological Survey of Canada, Paper 86-22, 63-70.
Asch, T. H. et al., 2008, ALLTEM UXO detection and discrimination: Society of Exploration Geophysicists, SEG Expanded Abstracts 27, 2892-2896.
Asch, T. H. et al., 2010, ALLTEM UXO classification and discrimination results from the Yuma proving ground standardized test site: in Proc. of the Symp. on the Application of Geophysics to Engineering and Environmental Problems, 1024-1037.
Asch, T. H. et al., 2009, The ALLTEM UXO detection and discrimination system, MK2: in Proc. of the Symp. on the Application of Geophysics to Engineering and Environmental Problems, 1083-1096.
Bell, T. et al., 2008, EMI Array for Cued UXO Discrimination: SEG Expanded Abstracts 27, 2907-2911.
Billings, S. D. et al., 2010, Unexploded ordnance discrimination using magnetic and electromagnetic sensors: Case study from a former military site: Geophysics, 75, B103-B114.
Best, M. E., and Bremner, T. G. T., 1986, The SWEEPEM airborne electromagnetic system, in Palacky, G. J., (Ed), Airborne resistivity mapping. Geological Survey of Canada, Paper 86-22, 71-77.
Chave, A. D. and Cox, C. S., 1982, Controlled electromagnetic sources for measuring electrical conductivity beneath the oceans, 1. Forward problem and model study: Journal of Geophysical Research, 87, 5327-5338.
Cheesman, S. J. et al., 1987, On the theory of sea-floor conductivity mapping using transient electromagnetic systems. Geophysics, 52, 204-217.
Cheesman, S. J. et al., 1988, First results of a new short baseline sea floor transient EM system. SEG Expanded Abstracts 7, 259-261.
Constable, S. and Srnka, L. J., 2007, An introduction to marine controlled-source electromagnetic methods for hydrocarbon exploration. Geophysics, 72, WA3-WA12.
Cox, L. H. et al., 2010, 3D inversion of frequency-domain AEM surveys with a moving footprint, SEG Expanded Abstracts 29, 639-643.
Davydycheva, S., 2010a, Separation of azimuthal effects for new-generation resistivity logging tools—Part I: Geophysics, 75, E31-E40.
Davydycheva, S., 2010b, 3D modeling of new-generation (1999-2010) resistivity logging tools, The Leading Edge, July, 780-789.
Ellingsrud, S. et al., 2002, Remote sensing of hydrocarbon layers by seabed logging (SBL): results from a cruise offshore Angola. The Leading Edge, 21, no 10, 972-982.
Fan, Y. et al., 2010, Increasing the sensitivity of Controlled Source Electromagnetics by using Synthetic Aperture, SEG Expanded Abstracts, 29, 805-810.
Fraser, D. C., 1972, A new multicoil aerial electromagnetic prospecting system: Geophysics, 37, 518-537.
Fraser, D. C., 1979, The multicoil II airborne electromagnetic system: Geophysics, 44, 1367-1394.
Gasperikova, E. et al., 2008, UXO discrimination using a multiple-component AEM system: SEG Expanded Abstracts 27, 2897-2901.
Golub, G. H., and C. F. Van Loan, 1996, Matrix computations, 3rd ed.: Johns Hopkins University Press.
Grant, F. S., and West, G. F., 1965, Interpretation theory in applied geophysics: McGraw-Hill.
Hefford, S. W. et al., 2006, Quantifying the effect that changes in transmitter-receiver geometry have on the capability of an airborne electromagnetic survey system to detect good conductors. Exploration and Mining Geology, 15, nos 1-2, 43-52.
Hogg, R. L. S., 1986, The Aerodat multigeometry, broadband transient helicopter electromagnetic system, in Palacky, G. J., Airborne resistivity mapping, Geol. Surv. Canada, Paper 86-22, 79-89.
Key, K. and Lockwood, A., 2010, Determining the orientation of marine CSEM receivers using orthogonal Procrustes rotation analysis. Geophysics 75, F63-F70.
Lück, E. and Müller, M., 2009, Forward to special issue, Near Surface Geophysics, 3.
MacGregor, L. M. and Sinha, M. C., 2000, Use of marine controlled source electromagnetic sounding for sub-basalt exploration, Geophysical Prospecting, 48, 1091-1106.
Nabighian, M. N., 1991, Electromagnetic methods in applied geophysics, volume 2 Applications, part A and B. Investigations in Geophysics 3. Society of Exploration Geophysicists, Tulsa.
Nabighian, M. N. and J. C. Macnae, 1991, Time domain electromagnetic prospecting methods, in M. N Nabighian, ed., Electromagnetic methods in applied geophysics, volume 2 Applications, part A and B: Society of Exploration Geophysicists, Investigations in Geophysics 3, 427-520.
Oldenburg D. W., Yang, D. and Haber E., 2010, Inversion of Multi-source TEM data with Applications to Mt. Milligan: SEG Expanded Abstracts 29, 3888-3892.
Parasnis, 1991, Large layout harmonic field systems, in M. N Nabighian, ed., Electromagnetic methods in applied geophysics, volume 2 part A: Society of Exploration Geophysicists, Investigations in Geophysics 3, 271-283.
Frischknecht, F. C. et al., 1991, Profiling methods using small sources, in M. N Nabighian, ed., Electromagnetic methods in applied geophysics, volume 2 part A: Society of Exploration Geophysicists, Investigations in Geophysics 3, 105-270.
Press, W. H. et al., 1992, Numerical recipes in C: the art of scientific computing second edition, Cambridge University Press.
Raab, F. H. et al., 1979, Magnetic position and orientation tracking system: IEEE transactions on aerospace and electronic systems, AES-15 (5), 709-718.
Smith, J. T. et al., 2007, Multitransmitter null coupled systems for inductive detection and characterization of metallic objects: Journal of Applied Geophysics, 61, 227-234.
Smith, R. S., 2001, On removing the primary field from fixed-wing time-domain airborne electromagnetic data: some consequences for quantitative modelling, estimating bird position and detecting perfect conductors: Geophysical Prospecting, 49, 405-416.
Smith, R. S. and Balch, S. J., 2000, Robust estimation of the in-phase response from impulse-response TEM measurements taken during the transmitter switch-off and the transmitter off time: Theory and an example from Voisey's Bay: Geophysics, 65, 476-481.
Smith, R. S. and Keating, P. B., 1996, The usefulness of multicomponent, time-domain airborne electromagnetic measurements: Geophysics, 61, 74-81.
Smith, R. S., Annan, A. P. and McGowan, P. D., 2001, A comparison of data from airborne, semi-airborne and ground electromagnetic systems: Geophysics, 1379-1385.
Snyder, D. D., and George, D. C., 2006, Qualitative and quantitative UXO detection with EMI using arrays of multi-component receivers, in Proc. of the Symp. on the Application of Geophysics to Engineering and Environmental Problems, 19, 1749-1760.
Snyder, D. D. et al., 2008, An assessment of three dipole-based programs for estimating UXO target parameters with induction EM, SEG Expanded Abstracts 27, 2902-2906.
Spies, B. R., 1975, The dual loop configuration of the transient electromagnetic method: Geophysics, 40, 1051-1057.
Telford et al. 1976, Applied Geophysics, Cambridge University Press, Cambridge, UK. Wang, G. L. et al., 2009, Fast simulation of triaxial borehole induction measurements acquired in axially symmetrical and transversely isotropic media: Geophysics, 74, E233-E249.
Ward, S. H., 1990, Geotechnical and environmental geophysics, 3 volumes, Investigations in Geophysics 5. Society of Exploration Geophysicists, Tulsa.
West, G. F., Macnae, J. C., and Lamontagne, Y., 1984, A time-domain electromagnetic system measuring the step response of the ground: Geophysics, 49, 1010-1026.
Wright, D. L. et al., 2005, ALLTEM, A triangle wave on-time time-domain system for UXO applications, in Proceedings of the Symposium on the Application of Geophysics to Engineering and Environmental Problems, 1357-1367.
Wright, D. L. et al., 2006, ALLTEM for UXO applications—first field tests, in Proc. of the Symp. on the Application of Geophysics to Engineering and Environmental Problems, 1761-1775.
Zhang, Y. et al., 2010, Dual-mode, fluxgate-Induction sensor for UXO detection and discrimination, Journal of environmental and engineering geophysics, 15(2), 51-64.

1. A method of electromagnetic sensing comprising the steps of:
a) driving each transmitter of a three-component electric or magnetic dipole transmitter provided at a transmitter location to generate three multiplexed electromagnetic fields, and, while driving each transmitter of said three-component transmitter, measuring signals with each receiver of a three-component receiver provided at a receiver location, thereby obtaining nine received signals;
b) repeating step (a) for a plurality of different transmitter locations, different receiver locations, or a combination thereof, thereby obtaining a set of received signals;
c) selecting a sensing direction and a sensing position;
d) determining a set of transmitter weights, such that wherein said weights are multiplied by electromagnetic fields produced at said sensing position by each transmitter at each transmitter location, and wherein a resulting set of weighted electromagnetic fields are summed over each transmitter location, a summed weighted field is enhanced in said sensing direction at said sensing position, and substantially suppressed at other positions and directions;
e) multiplying each signal of said set of received signals by a corresponding transmitter weight, wherein, for a given three-component receiver, said
corresponding transmitter weight is a weight determined in step (d) for a transmitter that was active when a signal was recorded with said given three-component receiver;
f) summing a resulting set of weighted signals to obtain a focused signal; and
g) inferring a presence or absence of a conductive body at said sensing position according to a strength of said focused signal.

2. The method according to claim 1, further comprising the steps of:
h) selecting one or more of an additional sensing direction and an additional sensing position; and
i) repeating steps d) to g).

3. The method according to claim 2 further comprising repeating steps h) and i) one or more times to scan one or more of a spatial and angular region.

4. The method according to claim 1 wherein a three-component transmitter is provided to one or more of said different transmitter locations by translating a single three-component transmitter.

5. The method according to claim 1 wherein a physically separate three-component transmitter is provided at one or more of said different transmitter locations.

6. The method according to claim 1 wherein a three-component receiver is provided to one or more of said different receiver locations by translating a single three-component receiver.

7. The method according to claim 1 wherein a physically separate three-component receiver is provided at one or more of said different receiver locations.

8. The method according to claim 1 wherein each said three-component receiver comprises three dipole receivers suitably arranged to be capable of detecting a electromagnetic field in any direction.

9. The method according to claim 1 further comprising the step of determining, based on said set of signals, a location from which a secondary electromagnetic field was generated.

10. The method according to claim 1 further comprising the step of calculating a reference signal produced by a theoretical conductive body located at said sensing position, and comparing said reference signal with said focused signal.

11. The method according to claim 10 wherein said step of comparing said reference signal with said focused signal comprises cross-correlating said reference signal with said focused signal.

12. The method according to claim 1 wherein said multiplexed electromagnetic fields are multiplexed in a time domain.

13. The method according to claim 1 wherein said multiplexed electromagnetic fields are multiplexed in a frequency domain.

14. A method of electromagnetic sensing comprising the steps of:
a) driving each transmitter of a three-component transmitter provided at a transmitter location to generate three multiplexed electromagnetic fields, and, while driving each transmitter of said three-component transmitter, measuring signals with each receiver of a three-component receiver provided at a receiver location, thereby obtaining nine received signals;
b) repeating step (a) for a plurality of different transmitter locations, different receiver locations, or a combination thereof, thereby obtaining a set of received signals;
c) forming an inverse problem comprising a set of equations relating said set of received signals to secondary electromagnetic fields generated by one or more subsurface conductive body in response to primary electromagnetic fields transmitted by said three-component transmitter; and
d) solving said inverse problem to obtain locations of said one or more subsurface conductive bodies.

15. A method of detecting the presence of a conductive body, said method comprising the steps of:
providing a three-component transmitter and a three-component receiver,
driving each transmitter of said three-component transmitter to generate three multiplexed electromagnetic fields;
detecting said three multiplexed electromagnetic fields with each receiver of said three-component receiver, thereby obtaining measured values for nine electromagnetic field components;
generating equations for predicting values of said nine electromagnetic field components;
inverting said equations to estimate a position and orientation of said three-component transmitter relative to said three-component receiver;
employing said position and orientation to calculate predicted values of said nine electromagnetic field components, and calculating a residual electromagnetic field by subtracting predicted values from said measured values; and
inferring a presence of a conductor based on a non-zero residual electromagnetic field.

16. The method according to claim 15 wherein said three-component transmitter comprises three non-coplanar dipole transmitters and said three-component receiver comprises three non-coplanar dipole receivers.

17. The method according to claim 15 wherein said step of inverting said equations comprises performing a non-linear iterative method.

18. The method according to claim 15 wherein said three-component transmitter and said three-component receiver are separated by an initially unknown distance.

19. The method according to claim 15 wherein said multiplexed electromagnetic fields are multiplexed in a time domain.

20. The method according to claim 15 wherein said multiplexed electromagnetic fields are multiplexed in a frequency domain.

21. A method of detecting the presence of a conductive body, said method comprising the steps of:
providing a three-component transmitter and a three-component receiver,
driving each transmitter of said three-component transmitter to generate three multiplexed electromagnetic fields;
detecting said three multiplexed electromagnetic fields with each receiver of said three-component receiver;
generating a set of invariant equations based on the three multiplexed electromagnetic fields;
solving said invariant equations to determine a position of said three-component transmitter relative to said three-component receiver;
rotating said three-component transmitter such that a transmitter of said three-component transmitter is directed along an axis passing through a location of said three-component transmitter and said three-component receiver; and
inferring a presence of a conductive body based on a non-zero value of one or more invariants, or a combination thereof, that are expected to be zero in absence of said conductive body.

22. The method according to claim 21 wherein said three-component transmitter comprises three non-coplanar dipole transmitters and said three-component receiver comprises three non-coplanar dipole receivers.

23. The method according to claim 21 wherein said multiplexed electromagnetic fields are mutually orthogonal at a location of said three-component receiver.

24. The method according to claim 21 wherein said three-component transmitter and said three-component receiver are separated by an initially unknown distance.

25. The method according to claim 21 wherein said multiplexed electromagnetic fields are multiplexed in a time domain.

26. The method according to claim 21 wherein said multiplexed electromagnetic fields are multiplexed in a frequency domain.
